(19) United States
(12) Patent Application Publication
(10) Pub. No.: US 2023/0104972 A1
(43) Pub. Date: Apr. 6, 2023

(54) PHYSICAL UPLINK SHARED CHANNEL (PUSCH) REPETITION COUNTING IN PAIRED SPECTRUM

(71) Applicant: QUALCOMM Incorporated, San Diego, CA (US)

(72) Inventors: Hung Dinh Ly, San Diego, CA (US); Gokul Sridharan, Sunnyvale, CA (US); Peter Gaal, San Diego, CA (US)

(21) Appl. No.: 17/934,511

(22) Filed: Sep. 22, 2022

Related U.S. Application Data
(60) Provisional application No. 63/251,568, filed on Oct. 1, 2021.

(51) Int. Cl. H04W 72/12; H04L 5/14; H04L 1/08

(52) U.S. Cl. CPC H04W 72/1268; H04L 5/14; H04L 1/08

(57) ABSTRACT

Techniques related to uplink transmission repetitions are disclosed. Some aspects of the disclosure relate to devices and methods for wireless communications that include transmitting or receiving repetitions of uplink transmissions. In one example, a user equipment (UE) and a scheduling entity can receive/transmit an indication of a repetition count from a scheduling entity; receive/transmit a resource allocation for a set of a plurality of slots on a first carrier; and transmit/receive repetitions of an uplink transmission on a subset of the plurality of slots on the first carrier. Here, the first carrier is paired with a second carrier and separated from the second carrier in frequency. Also, the UE operates in a half duplex communication, and a quantity of the repetitions transmitted is based on the repetition count. Other aspects, embodiments, and features are also claimed and described.

### PRIORITY CLAIM

This application claims priority to and the benefit of provisional patent application No. 63/251,568, filed in the U.S. Patent and Trademark Office on Oct. 1, 2021, the entire content of which is incorporated herein by reference as if fully set forth below in its entirety and for all applicable purposes.

### TECHNICAL FIELD

The technology discussed below relates generally to wireless communication systems, and more particularly, to uplink resource allocation, and more particularly, to physical uplink shared channel (PUSCH) repetition.

### INTRODUCTION

As the demand for mobile broadband access continues to increase, research and development continue to advance wireless communication technologies not only to meet the growing demand for mobile broadband access, but to advance and enhance the user experience with mobile communications having better coverage. For example, a physical uplink channel (PUSCH) having further improved reliability and coverage based on PUSCH repetition could improve user experience.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In some aspects of the disclosure, a user equipment (UE) receives an indication of a repetition count from a scheduling entity. The UE further receives a resource allocation for a set of a plurality of slots on a first carrier. The first carrier is paired with a second carrier and separated from the second carrier in frequency. The UE operates in a half duplex communication. The UE further transmits repetitions of an uplink transmission on a subset of the plurality of slots on the first carrier, wherein a quantity of the repetitions transmitted is based on the repetition count.

In some aspects of the disclosure, a scheduling entity transmits an indication of a first repetition count to a first user equipment (UE). The scheduling entity further transmits, to the first UE, a first resource allocation for a set of a plurality of first slots on a first carrier. The first carrier is paired with a second carrier and separated from the second carrier in frequency. The first UE operates in a half-duplex communication. The scheduling entity further receives, from the first UE, repetitions of a first uplink transmission on a first subset of the plurality of first slots on the first carrier, wherein a first quantity of the repetitions that are received is based on the first repetition count.

These and other aspects of the invention will become more fully understood upon a review of the detailed description, which follows. Other aspects and features will become apparent to those of ordinary skill in the art, upon reviewing the following description of specific, exemplary features in conjunction with the accompanying figures. While the following description may discuss various advantages and features relative to certain features, all features can include one or more of the advantageous features discussed herein. In other words, while this description may discuss one or more features as having certain advantageous features, one or more of such features may also be used in accordance with the various features discussed herein. In similar fashion, while this description may discuss exemplary features as device, system, or method features it should be understood that such exemplary features can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a schematic illustration of an organization of wireless resources in an air interface utilizing orthogonal frequency divisional multiplexing (OFDM) according to some features.

FIG. 4 is a conceptual illustration of frequency division duplex (FDD) and time division duplex (TDD) examples having multiple repetitions of an uplink transmission according to some aspects of the disclosure.

FIG. 5 is a schematic illustration of wireless communication system with PUSCH repetition counting procedures according to some aspects of the disclosure.

FIG. 6 is a block diagram conceptually illustrating an example of a hardware implementation for a scheduling entity according to some aspects of the disclosure.

FIG. 7 is a block diagram conceptually illustrating an example of a hardware implementation for a scheduled entity according to some aspects of the disclosure.

FIG. 8 is a flow chart illustrating an exemplary process of a user equipment (UE) for an uplink transmission based on PUSCH repetition counting according to some aspects of the disclosure.

FIG. 9 is a conceptual illustration of a full duplex operation in paired spectrum and a half duplex operation in paired spectrum according to some aspects of the disclosure.

FIG. 10A is a conceptual illustration of a PUSCH repetition counting procedure according to some aspects of the disclosure.

FIG. 10B is a conceptual illustration of a PUSCH repetition counting procedure according to other aspects of the disclosure.

FIG. 11A is a conceptual illustration of a PUSCH repetition counting procedure according to some aspects of the disclosure.

FIG. 11B is a conceptual illustration of a PUSCH repetition counting procedure according to other aspects of the disclosure.

FIG. 12 is a flow chart illustrating an exemplary process of a base station for an uplink transmission based on PUSCH repetition counting according to some aspects of the disclosure.

FIG. 13 is another flow chart illustrating an exemplary process of a base station for an uplink transmission based on PUSCH repetition counting according to some aspects of the disclosure.

FIG. 14 is a flow chart illustrating an exemplary process for a UE implementing collision handling according to some aspects of the disclosure.

FIG. 15 is another flow chart illustrating an exemplary process for a UE implementing collision handling according to further aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes aspects and features by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, features and/or uses may come about via integrated chip features and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described features. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

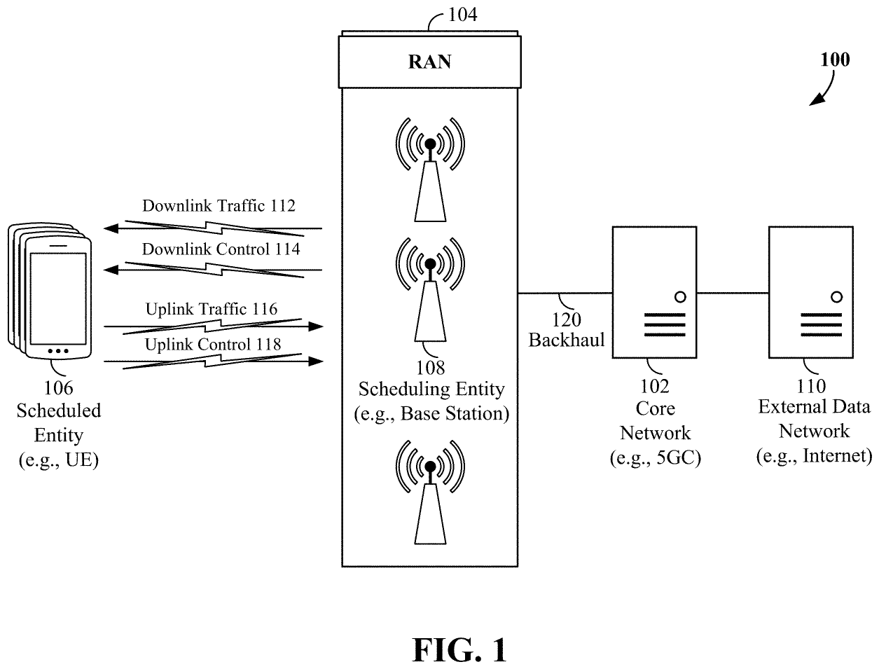

The disclosure that follows presents various concepts that may be implemented across a broad variety of telecommunication systems, network architectures, and communication standards. Referring now to FIG. 1, as an illustrative example without limitation, this schematic illustration shows various aspects of the present disclosure with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The radio access network 104 supports wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides access to network services.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled. In scheduled operational scenarios, a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 may broadcast downlink traffic 112 to one or more scheduled entities 106. Broadly, the scheduling entity 108 can be a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

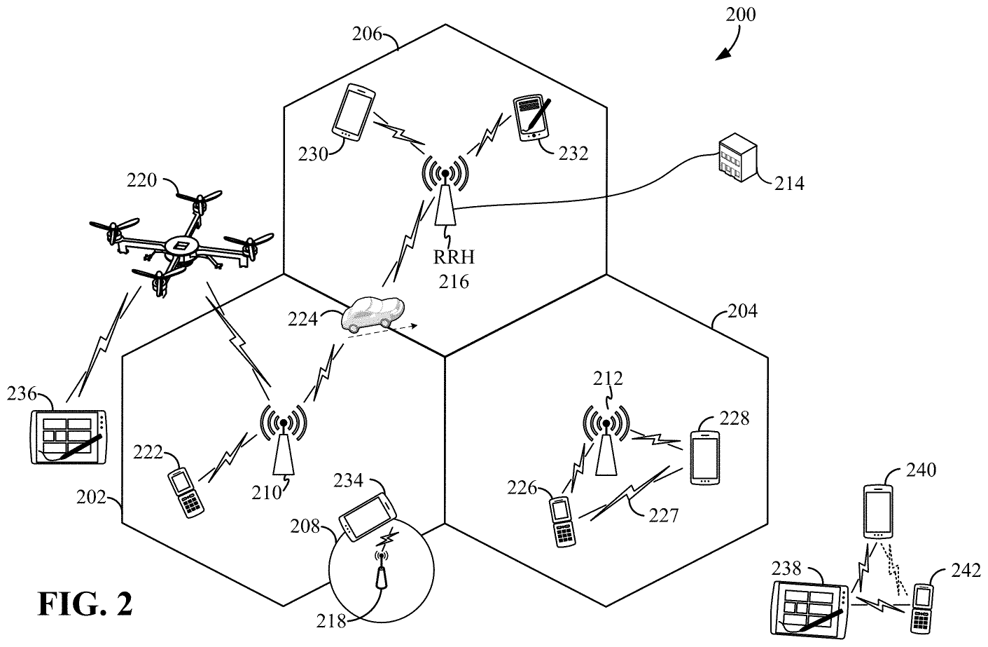

Referring now to FIG. 2, by way of example and without limitation, a schematic illustration of a RAN 200 is provided. In some examples, the RAN 200 may be the same as the RAN 104 described above and illustrated in FIG. 1. The geographic area covered by the RAN 200 may be divided into cellular regions (cells) that can be uniquely identified by a user equipment (UE) based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In FIG. 2, two base stations 210 and 212 are shown in cells 202 and 204; and a third base station 214 is shown controlling a remote radio head (RRH) 216 in cell 206. That is, a base station can have an integrated antenna or can be connected to an antenna or RRH by feeder cables. In the illustrated example, the cells 202, 204, and 126 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

The radio access network 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

FIG. 2 further includes a quadcopter or drone 220, which may be configured to function as a base station. That is, in some examples, a cell may not necessarily be stationary, and the geographic area of the cell may move according to the location of a mobile base station such as the quadcopter 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as the UE/scheduled entity 106 described above and illustrated in FIG. 1.

In some examples, a mobile network node (e.g., quadcopter 220) may be configured to function as a UE. For example, the quadcopter 220 may operate within cell 202 by communicating with base station 210.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the scheduling entity 238. Thus, in a wireless communication system with scheduled access to time-frequency resources and having a cellular configuration, a P2P configuration, or a mesh configuration, a scheduling entity and one or more scheduled entities may communicate utilizing the scheduled resources.

In the radio access network 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

The air interface in the radio access network 200 may utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot.

The air interface in the radio access network 200 may further utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes. For example, a UE may provide for UL multiple access utilizing time division multiple access (TDMA), code division multiple access (CDMA), frequency division multiple access (FDMA), sparse code multiple access (SCMA), resource spread multiple access (RSMA), or other suitable multiple access schemes. Further, a base station 210 may multiplex DL transmissions to UEs 222 and 224 utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

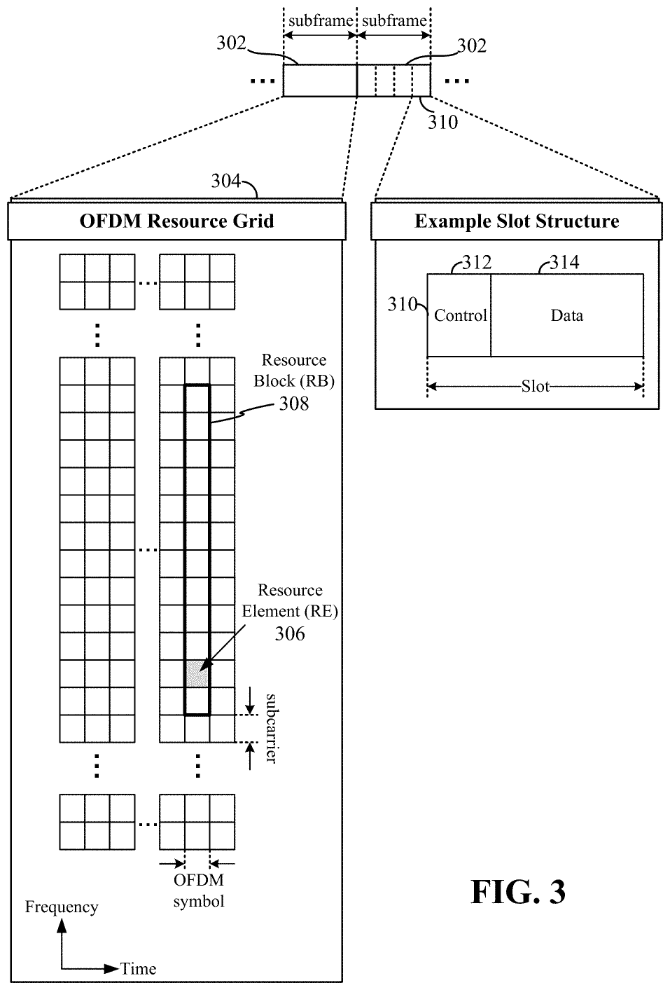

Various aspects of the present disclosure will be described with reference to an OFDM waveform, schematically illustrated in FIG. 3. It should be understood by those of ordinary skill in the art that the various aspects of the present disclosure may be applied to a DFT-s-OFDMA waveform in substantially the same way as described herein below. That is, while some examples of the present disclosure may focus on an OFDM link for clarity, it should be understood that the same principles may be applied as well to DFT-s-OFDMA waveforms.

In some examples, a frame may refer to a predetermined duration of time (e.g., 10 ms) for wireless transmissions. And further, each frame may consist of a set of subframes (e.g., 10 subframes of 1 ms each). On a given carrier, there may be one set of frames in the UL, and another set of frames in the DL. Referring now to FIG. 3, an expanded view of an exemplary DL subframe 302 is illustrated, showing an OFDM resource grid 304. However, as those skilled in the art will readily appreciate, the PHY transmission structure for any particular application may vary from the example described here, depending on any number of factors. As illustrated, time is in the horizontal direction with units of OFDM symbols; and frequency is in the vertical direction with units of subcarriers or tones.

The resource grid 304 may be used to schematically represent time-frequency resources for a given antenna port. That is, in a MIMO implementation with multiple antenna ports available, a corresponding multiple number of resource grids 304 may be available for communication. The resource grid 304 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A UE generally utilizes only a subset of the resource grid 304. An RB may be the smallest unit of resources that can be allocated to a UE. Thus, the more RBs scheduled for a UE, and the higher the modulation scheme chosen for the air interface, the higher the data rate for the UE.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each subframe 302 (e.g., a 1 ms subframe) may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., 1, 2, 4, or 7 OFDM symbols). These mini-slots may in some cases be transmitted occupying resources scheduled for ongoing slot transmissions for the same or for different UEs.

An expanded view of one of the slots 310 illustrates the slot 310 including a control region 312 and a data region 314. In general, the control region 312 may carry control channels (e.g., PDCCH), and the data region 314 may carry data channels (e.g., PDSCH or PUSCH). Of course, a slot may contain all DL, all UL, or at least one DL portion and at least one UL portion. The simple structure illustrated in FIG. 3 is merely exemplary in nature, and different slot structures may be utilized, and may include one or more of each of the control region(s) and data region(s).

Although not illustrated in FIG. 3, the various REs 306 within an RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In a DL transmission, the transmitting device (e.g., the scheduling entity 108) may allocate one or more REs 306 (e.g., within a control region 312) to carry DL control information 114 including one or more DL control channels that generally carry information originating from higher layers, such as a physical broadcast channel (PBCH), a physical downlink control channel (PDCCH), etc., to one or more scheduled entities 106. In addition, DL REs may be allocated to carry DL physical signals that generally do not carry information originating from higher layers. These DL physical signals may include a primary synchronization signal (PSS); a secondary synchronization signal (SSS); demodulation reference signals (DM-RS); phase-tracking reference signals (PT-RS); channel-state information reference signals (CSI-RS); etc.

The synchronization signals PSS and SSS (collectively referred to as SS), and in some examples, the PBCH, may be transmitted in an SS block that includes 4 consecutive OFDM symbols, numbered via a time index in increasing order from 0 to 3. In the frequency domain, the SS block may extend over 240 contiguous subcarriers, with the subcarriers being numbered via a frequency index in increasing order from 0 to 239. Of course, the present disclosure is not limited to this specific SS block configuration. Other nonlimiting examples may utilize greater or fewer than two synchronization signals; may include one or more supplemental channels in addition to the PBCH; may omit a PBCH; and/or may utilize nonconsecutive symbols for an SS block, within the scope of the present disclosure.

The PDCCH may carry downlink control information (DCI) for one or more UEs in a cell. This can include, but is not limited to, power control commands, scheduling information, a grant, and/or an assignment of REs for DL and UL transmissions.

In an UL transmission, a transmitting device (e.g., a scheduled entity 106) may utilize one or more REs 306 to carry UL control information 118 (UCI). The UCI can originate from higher layers via one or more UL control channels, such as a physical uplink control channel (PUCCH), a physical random access channel (PRACH), etc., to the scheduling entity 108. In addition, UCI may be carried by a physical uplink shared channel (PUSCH). Further, UL REs may carry UL physical signals that generally do not carry information originating from higher layers, such as demodulation reference signals (DM-RS), phase-tracking reference signals (PT-RS), sounding reference signals (SRS), etc. In some examples, the DMRS may be in use for, among others, estimating a channel. In some examples, the control information 118 may include a scheduling request (SR), i.e., a request for the scheduling entity 108 to schedule uplink transmissions. Here, in response to the SR transmitted on the control channel 118, the scheduling entity 108 may transmit downlink control information 114 that may schedule resources for uplink packet transmissions.

UCI may also include hybrid automatic repeat request (HARQ) feedback such as an acknowledgment (ACK) or negative acknowledgment (NACK), channel state information (CSI), or any other suitable UL control information. HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission confirmed, an ACK may be transmitted, whereas if not confirmed, a NACK may be transmitted. In response to a NACK, the transmitting device may send a HARQ retransmission, which may implement chase combining, incremental redundancy, etc.

In addition to control information, one or more REs 306 (e.g., within the data region 314) may be allocated for user data or traffic data. Such traffic may be carried on one or more traffic channels, such as, for a DL transmission, a physical downlink shared channel (PDSCH); or for an UL transmission, a physical uplink shared channel (PUSCH). Unlike PDSCH, a PUSCH may carry UL control information.

In order for a UE to gain initial access to a cell, the RAN may provide system information (SI) characterizing the cell. This system information may be provided utilizing minimum system information (MSI), and other system information (OSI). The MSI may be periodically broadcast over the cell to provide the most basic information a UE requires for initial cell access, and for acquiring any OSI that may be broadcast periodically or sent on-demand. In some examples, a network may provide MSI over two different downlink channels. For example, the PBCH may carry a master information block (MIB), and the PDSCH may carry a system information block type 1 (SIB1). Here, the MIB may include a UE with parameters for monitoring a control resource set. The control resource set may thereby provide the UE with scheduling information corresponding to the PDSCH, e.g., a resource location of SIB1. In the art, SIB1 may be referred to as remaining minimum system information (RMSI).

OSI may include any SI that is not broadcast in the MSI. In some examples, the PDSCH may carry a plurality of SIBs, not limited to SIB1, discussed above. Here, the OSI may be provided in these SIBs, e.g., SIB2 and above.

The channels or carriers described above and illustrated in FIGS. 1 and 3 are not necessarily all the channels or carriers that may be utilized between a scheduling entity 108 and scheduled entities 106, and those of ordinary skill in the art will recognize that other channels or carriers may be utilized in addition to those illustrated, such as other traffic, control, and feedback channels.

In some examples, a physical layer may generally multiplex and map these physical channels described above to transport channels for handling at a medium access control (MAC) layer entity. Transport channels carry blocks of information called transport blocks (TB). The transport block size (TBS), which may correspond to a number of bits of information, may be a controlled parameter, based on the modulation and coding scheme (MCS) and the number of RBs in a given transmission.

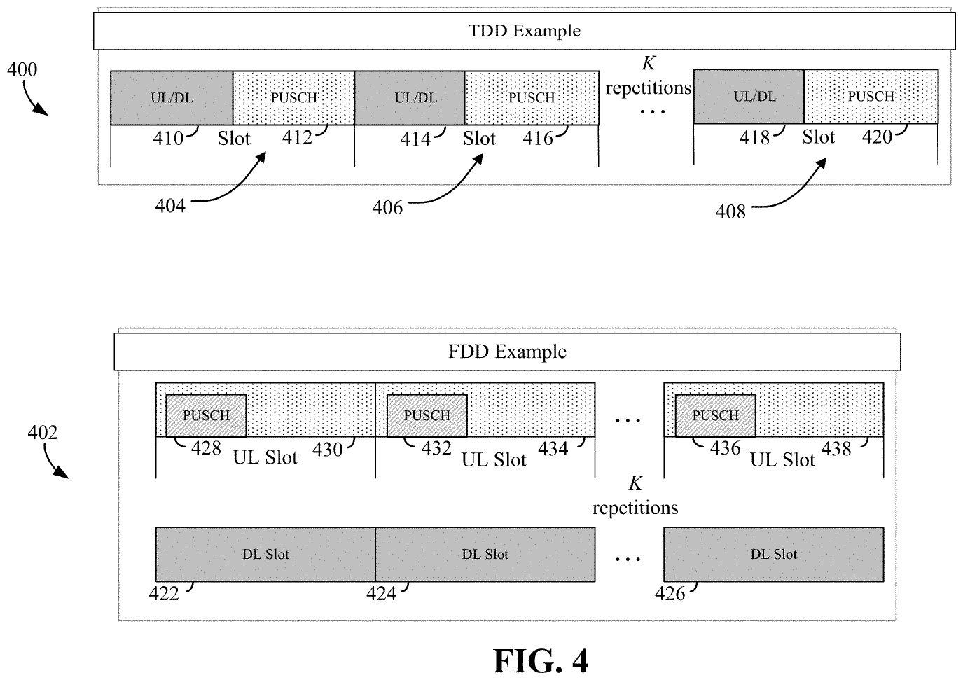

FIG. 4 is a conceptual illustration of frequency division duplex (FDD) and time division duplex (TDD) examples having multiple repetitions of an uplink transmission according to some aspects of the disclosure. For example, a first example 400 shows such a transmission on a time division duplex (TDD) carrier. A second example 402 shows such a transmission on a frequency division duplex (FDD) carrier. As described further below, a UE may transmit one or more repetitions of an uplink transmission on corresponding PUSCHs in multiple corresponding slots. The uplink transmission may include a transport block (TB).

Multiple PUSCH repetition types may exist. These may include a first and second type (sometimes referred to as Type A and Type B). Type A uses the same symbol allocation in each slot applied across repeated PUSCH transmissions while Type B employs a different symbol allocation in slots applied across repeated PUSCH transmissions. That is, in Type A, the starting symbol S relative to the start of the slot, and the number of consecutive symbols L counting from the symbol S allocated for the PUSCH are determined from the start and length indicator SLIV of the indexed row. Here, in Type A, the uplink transmission may be allocated on the same portion and location of each slot while in Type B, the uplink transmission may not. In Type A, the UE may determine the number of repetitions based on available UL slots or allocated DL/UL slots. In some examples, the UE may determine the number of repetitions by receiving an indication of a repetition count (e.g., the numberOfRepetitions value from the scheduling entity). In further examples, the indication of a repetition count (e.g., the numberOfRepetitions value) may be present in a resource allocation table of a resource allocation from the scheduling entity. In other examples, the UE may configure the repetition count based on an aggregation factor (e.g., pusch-AggregationFactor). In the examples, when the UE is configured with the aggregation factor, the repetition count may be equal to the aggregation factor (e.g., pusch-AggregationFactor). The scheduling entity may directly inform the indication of the repetition count (e.g., the number of repetitions) to the UE through various ways including a random access response (RAR) message, a radio resource control (RRC) message, a medium access control (MAC) control element (MAC-CE) message, a downlink control information (DCI) message, and any other suitable message.

In a TDD carrier example 400, multiple slots labeled 404, 406, and 408 are shown on the TDD carrier. The first slot 404 includes a first region 410 (which can include uplink, downlink, or a suitable combination of these), and an uplink region 412. The uplink region 412 may include a PUSCH on which a given UE has a resource assignment or grant for an uplink transmission. In some examples, the uplink transmission in the PUSCH 412 may be a transport block (TB). As illustrated, a second slot 406 has a similar format, including a first region 414 and an uplink region 416. The second slot 406 may be a slot for message repetition. That is, the message 412 (e.g., an uplink transmission) in the first slot 404 may be the same as the message 416 in the second slot 406. Similarly, the k slot 408 may a slot for the same repeated message 420 (K repetitions). In some examples, the UE may repeat the message 412, 416, 420 (e.g., an uplink transmission including a TB) across the k slots applying the same symbol allocation in each slot 404, 406, 408. According to an aspect of the present disclosure, the UE may transmit one or more repetitions of an uplink transmission (e.g., a TB) on corresponding PUSCHs in respective slots based on a repetition count (e.g., the number of repetition) indicated by the scheduling entity. Although the slots 404, 406 are illustrated as being contiguous, in other examples these slots may not be contiguous. That is, a gap of one or more slots may appear between repetitions of a transmitted message as described herein. Additionally, in other examples, the UE can transmit any suitable number of repetitions across a set of slots (e.g., K repetitions). In further aspects of the disclosure, the TDD carrier for one communication direction under half duplex operation may be paired with another TDD carrier for another communication direction under the half duplex operation.

In example 402, the uplink component carrier of the FDD carrier includes multiple uplink slots 430, 434, and 438, and the downlink component carrier includes multiple downlink slots 422, 424, and 426. The first uplink slot 430 may include a PUSCH 428 on which a given UE has a resource assignment or grant for a transmission. According to an aspect of the present disclosure, a UE may transmit multiple repetitions of an uplink transmission (e.g., a TB, a packet or a message) on PUSCHs in respective uplink slots. The second uplink slot 434 may be a slot for message repetition. That is, the uplink transmission 432 in the second uplink slot 434 may be the same as the uplink transmission 428 in the first uplink slot 430. Similarly, the K uplink slot 438 may be a slot for message repetition and the uplink transmission 436 in the K uplink slot 438 may be the same as the uplink transmission 428 in the first uplink slot 430. Similar to the example 400, in example 402, although the uplink slots 430, 434 are illustrated as being contiguous, in other examples these UL slots may not be contiguous. That is, a gap (e.g., guard symbols) of one or more slots may appear between repetitions of a transmitted message as described herein. Additionally, the UE can transmit any suitable number of repetitions (e.g., K repetitions).

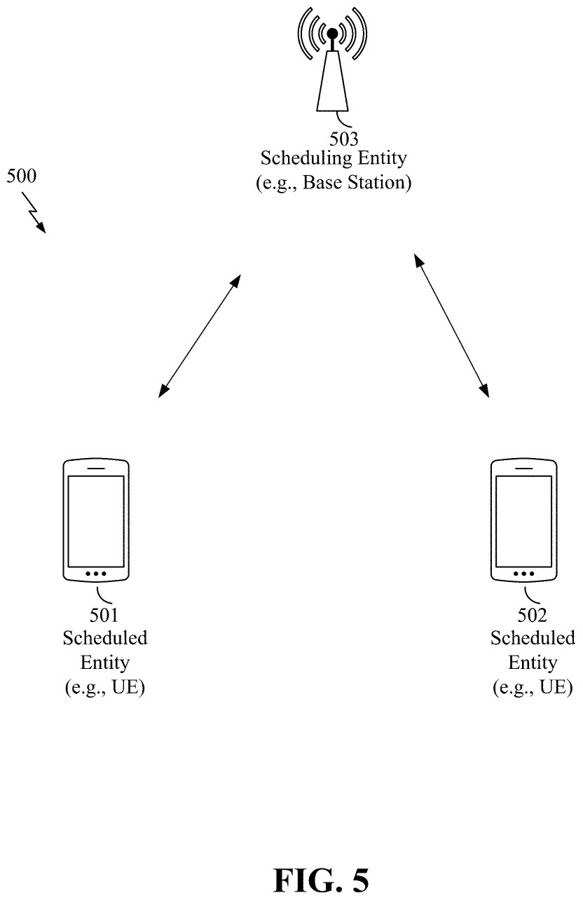

FIG. 5 is a schematic illustration of wireless communication system 500 with PUSCH repetition counting procedures according to some aspects of the disclosure. The system 500 includes a first UE 501, a second UE 502, and a scheduling entity 503. In some examples, additional or fewer UEs and scheduling entities are included in the system 500. The first UE 501 may be configured for half duplex communication, while the second UE 502 may be configured for full duplex operation. In other examples, the first UE 501 uses full duplex communication and/or the second UE 502 uses half duplex operation. Additionally, the scheduling entity 503 may be configured to communicate with the first UE 501 and/or the second UE 502 via paired spectrums (e.g., via a first paired spectrum allocation for the UE 501 and a second paired spectrum allocation for the second UE 502).

In operation, in some examples, the scheduling entity 503 may transmit an indication of a first repetition count to a first UE 501 and an indication of a second repetition count to a second UE 502. The scheduling entity 503 may also transmit a first resource allocation to the first UE 501 for a set of plurality of first slots on a first carrier paired with a second carrier. The scheduling entity 503 may transmit a second resource allocation to the second UE 502 for a set of plurality of second slots on a third carrier paired with a fourth carrier. The scheduling entity 503 may receive from the first UE 501 repetitions of a first uplink transmission on the first subset of the plurality of the first slots on the first carrier and receive from the second UE 502 repetitions of a second uplink transmission on the second subset of the plurality of the second slots on the third carrier.

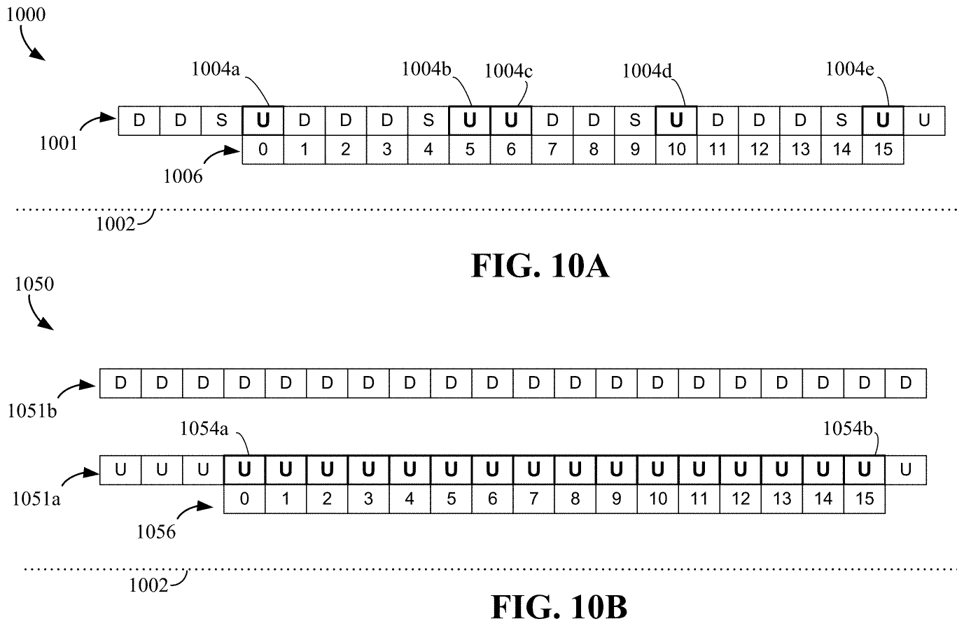

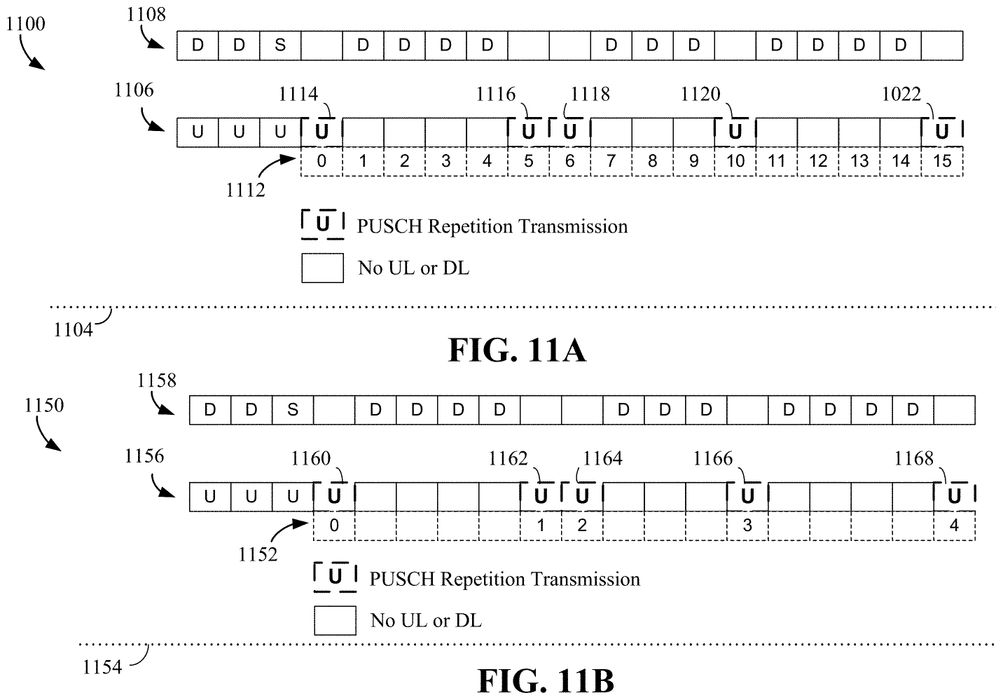

In some examples, the system 500 may implement a repetition counting procedure or multiple repetition counting procedures. Generally, a repetition counting procedure enables a UE to track the number of repetitions that the UE has transmitted and determine when to cease transmitting repetitions. Similarly, a repetition counting procedure enables a scheduling entity to track the number of repetitions that the scheduling entity has received from a UE and determine when to cease receiving or listening for further repetitions. For example, in a first repetition counting procedure, the quantity of repetitions transmitted by a UE (e.g., the UE 501 or 502) and received by a scheduling entity (e.g., the scheduling entity 503) may be based on a count of uplink and downlink slots of the set of the plurality of slots from a first repetition of the uplink transmission until the count reaches the repetition count. In a second repetition counting procedure, the quantity of repetitions transmitted by a UE (e.g., the UE 501 or 502) and received by a scheduling entity (e.g., the scheduling entity 503) may be based on a count of available uplink slots of the set of the plurality of slots from a first repetition of the uplink transmission until the count reaches the repetition count. Further details of repetition counting procedures are provided herein with respect to FIGS. 10 and 11.

In some examples, both the first UE 501 and the second UE 502 use the same repetition counting procedure when sending repetitions to the scheduling entity 503. In some examples, the first UE 501 and the second UE 502 use different repetition counting procedures when sending repetitions to the scheduling entity 503. In some examples, one or both of the UEs 501 and 502 may have fixed repetition counting procedures. Additionally, one or both of the UEs 501 and 502 may have configurable repetition counting procedures (e.g., configured based on respective indication(s) received from the scheduling entity 503). The scheduling entity 503 may be configured to use the same repetition counting procedure to track repetitions received from a particular UE as the UE is using to track repetitions transmitted by the UE. In this way, the scheduling entity 503 and the UE may coordinate transmission and receipt of repetitions.

In some examples, the first UE 501 operates in half duplex communication, the second UE 502 operates in full duplex communication, the scheduling entity 503 allocates respective paired spectrums to each of the first UE 501 and the second UE 502, and both the first UE 501 and the second UE 502 use fixed repetition counting procedures. In some of these examples, the first UE 501 and the second UE 502 may both use the first repetition counting procedure. In some of these examples, the first UE 501 and the second UE 502 may both use the second repetition counting procedure. In some of these examples, the first UE 501 use the first repetition counting procedure and the second UE 502 uses the second repetition counting procedure. In some of these examples, the first UE 501 use the second repetition counting procedure and the second UE 502 uses the first repetition counting procedure.

In some examples, the first UE 501 operates in half duplex communication, the second UE 502 operates in full duplex communication, the scheduling entity 503 allocates respective paired spectrums to each of the first UE 501 and the second UE 502, the first UE 501 uses a fixed repetition counting procedure, and the second UE 502 uses a configurable repetition counting procedure. In some of these examples, the first UE 501 uses the first repetition counting procedure and the second UE 502 is configured by the scheduling entity 503 to use either the first repetition counting procedure or the second repetition counting procedure. In some of these examples, the first UE 501 use the second repetition counting procedure and the second UE 502 is configured by the scheduling entity to use either the first repetition counting procedure or the second repetition counting procedure.

In some examples, the first UE 501 operates in half duplex communication, the second UE 502 operates in full duplex communication, the scheduling entity 503 allocates respective paired spectrums to each of the first UE 501 and the second UE 502, the first UE 501 uses a configurable repetition counting procedure, and the second UE 502 uses a fixed repetition counting procedure. In some of these examples, the second UE 502 uses the first repetition counting procedure and the first UE 501 is configured by the scheduling entity 503 to use either the first repetition counting procedure or the second repetition counting procedure. In some of these examples, the second UE 502 uses the second repetition counting procedure and the first UE 501 is configured by the scheduling entity 503 to use either the first repetition counting procedure or the second repetition counting procedure.

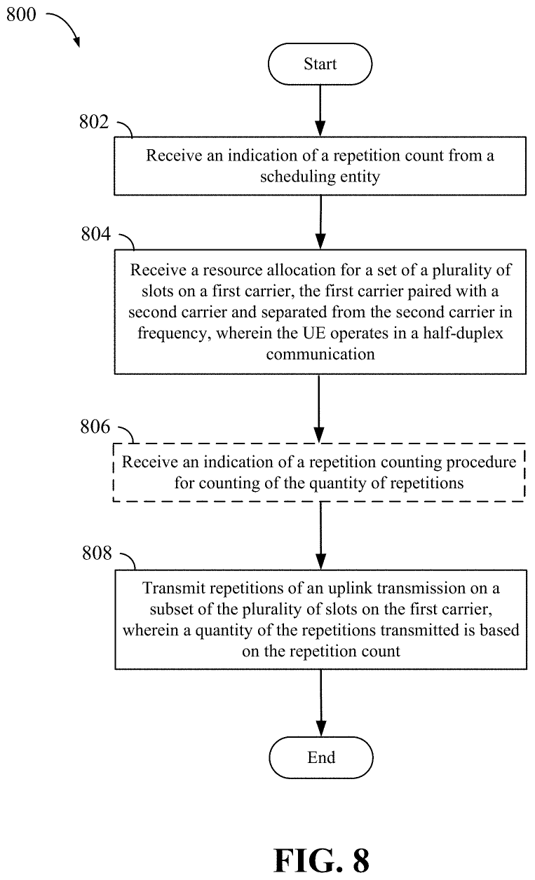

The repetition transmissions and counting procedures for UEs supporting full duplex or half duplex operation with paired spectrum allocations are further described in connection with FIGS. 8-12.

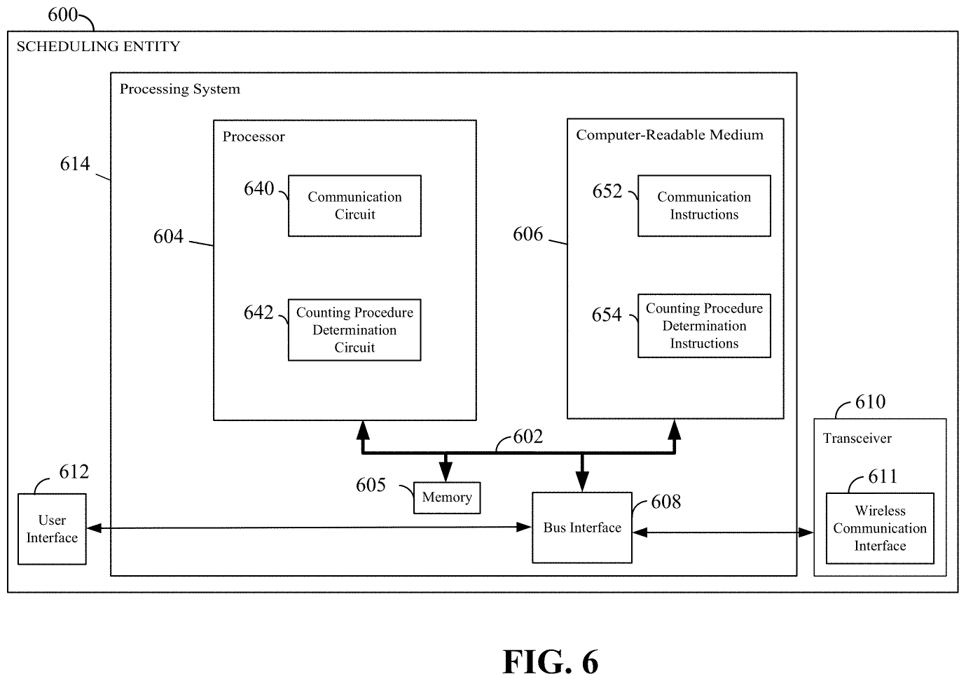

FIG. 6 is a block diagram illustrating an example of a hardware implementation for a scheduling entity 600 employing a processing system 614. For example, the scheduling entity 600 may be a gNB, a base station, or other transmission reception point (TRP) as illustrated in any one or more of FIGS. 1, 2, 4, 5, and/or 10. In another example, the scheduling entity 660 may be a user equipment (UE) as illustrated in any one or more of FIGS. 1, 2, 4, 5, 8, 12, and/or 13.

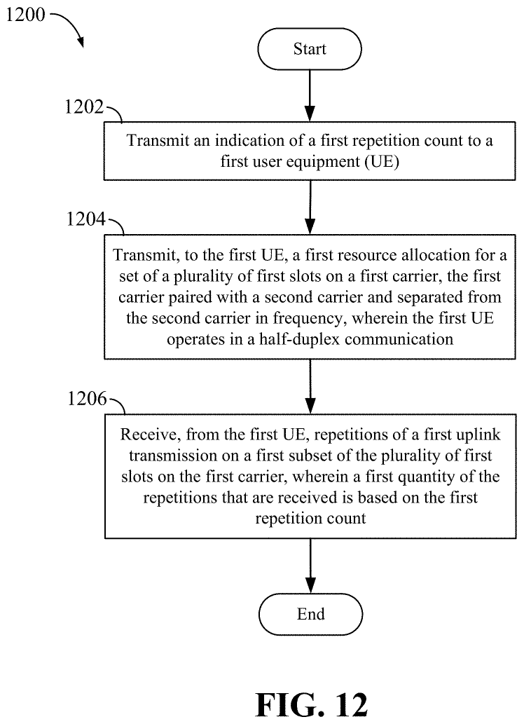

The scheduling entity 600 may be implemented with a processing system 614 that includes one or more processors 604. Examples of processors 604 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the scheduling entity 600 may be configured to perform any one or more of the functions described herein. That is, the processor 604, as utilized in a scheduling entity 600, may be configured (e.g., in coordination with the memory 605) to implement any one or more of the processes and procedures described below and illustrated in FIGS. 8, 12, and/or 13.

In this example, the processing system 614 may be implemented with a bus architecture, represented generally by the bus 602. The bus 602 may include any number of interconnecting buses and bridges depending on the specific application of the processing system 614 and the overall design constraints. The bus 602 communicatively couples together various circuits including one or more processors (represented generally by the processor 604), a memory 605, and computer-readable media (represented generally by the computer-readable medium 606). The bus 602 may also link various other circuits such as timing sources, peripherals, voltage regulators, and power management circuits, which are well known in the art, and therefore, will not be described any further. A bus interface 608 provides an interface between the bus 602 and a transceiver 610. The transceiver 610 provides a communication interface or means for communicating with various other apparatus over a transmission medium. For example, the transceiver 610 may include a wireless communication interface 611 configured for wireless transmission and/or reception over a radio access network. Depending upon the nature of the network node, a user interface 612 (e.g., keypad, display, speaker, microphone, joystick) may also be provided. Of course, such a user interface 612 is optional, and may be omitted in some examples, such as a base station.

In some aspects of the disclosure, the processor 604 may include communication circuitry 640 configured (e.g., in coordination with the memory 605) for various functions, including, for example, transmitting an indication of a first repetition count to a first user equipment (UE); transmitting, to the first UE, a first resource allocation for a set of a plurality of first slots on a first carrier; receiving, from the first UE, repetitions of a first uplink transmission on a first subset of the plurality of first slots on the first carrier; transmitting an indication of a second repetition count to a second UE; transmitting, to the second UE, a second resource allocation for a set of the plurality of second slots on a third carrier; receiving, from the second UE, repetitions of a second uplink transmission on a second subset of the second plurality of slots on the third carrier; transmitting, to the first UE, a first indication of the first repetition counting procedure; transmitting, to the second UE, a second indication of the second repetition counting procedure; transmitting, to the first UE, a first indication of the first repetition counting procedure; transmitting, to the second UE, a second indication of the second repetition counting procedure; and/or transmitting, to the first UE, a first indication of a first repetition counting procedure. For example, the communication circuitry 640 may be configured to implement one or more of the functions described below in relation to blocks 1202, 1204, 1206, 1302, 1304, and/or 1306 of FIGS. 12 and/or 13.

In further aspects of the disclosure, the processor 604 may include counting procedure determination circuit 642 configured (e.g., in coordination with the memory 605) for various functions, including, for example, determining the first repetition counting procedure for the first or second UE; and/or determining the second repetition counting procedure for the first or second UE. For example, the counting procedure determination circuitry 642 may be configured to implement one or more of the functions described below in relation to blocks 1206 and/or 1306 of FIGS. 12 and/or 13.

The processor 604 is responsible for managing the bus 602 and general processing, including the execution of software stored on the computer-readable medium 606. The software, when executed by the processor 604, causes the processing system 614 to perform the various functions described below for any particular apparatus. The computer-readable medium 606 and the memory 605 may also be used for storing data that is manipulated by the processor 604 when executing software.

One or more processors 604 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 606. The computer-readable medium 606 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 606 may reside in the processing system 614, external to the processing system 614, or distributed across multiple entities including the processing system 614. The computer-readable medium 606 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In some aspects of the disclosure, the computer-readable storage medium 606 may store computer-executable code that includes communication instructions 652 that configure a scheduling entity 600 for various functions, including, e.g., transmitting an indication of a first repetition count to a first user equipment (UE); transmitting, to the first UE, a first resource allocation for a set of a plurality of first slots on a first carrier; receiving, from the first UE, repetitions of a first uplink transmission on a first subset of the plurality of first slots on the first carrier; transmitting an indication of a second repetition count to a second UE; transmitting, to the second UE, a second resource allocation for a set of the plurality of second slots on a third carrier; receiving, from the second UE, repetitions of a second uplink transmission on a second subset of the second plurality of slots on the third carrier; transmitting, to the first UE, a first indication of the first repetition counting procedure; transmitting, to the second UE, a second indication of the second repetition counting procedure; transmitting, to the first UE, a first indication of the first repetition counting procedure; transmitting, to the second UE, a second indication of the second repetition counting procedure; and/or transmitting, to the first UE, a first indication of a first repetition counting procedure. Additionally, counting procedure determination instructions 654 can be configured for determining the first repetition counting procedure for the first or second UE; and/or determining the second repetition counting procedure for the first or second UE.

In one configuration, the scheduling entity 600 includes means for transmitting on a downlink traffic channel and/or downlink control channel, means for transmitting an indication of a first repetition count to a first user equipment (UE); means for transmitting, to the first UE, a first resource allocation for a set of a plurality of first slots on a first carrier; means for receiving, from the first UE, repetitions of a first uplink transmission on a first subset of the plurality of first slots on the first carrier; transmitting an indication of a second repetition count to a second UE; means for transmitting, to the second UE, a second resource allocation for a set of the plurality of second slots on a third carrier; means for receiving, from the second UE, repetitions of a second uplink transmission on a second subset of the second plurality of slots on the third carrier; means for transmitting, to the first UE, a first indication of the first repetition counting procedure; means for transmitting, to the second UE, a second indication of the second repetition counting procedure; means for transmitting, to the first UE, a first indication of the first repetition counting procedure; means for transmitting, to the second UE, a second indication of the second repetition counting procedure; means for transmitting, to the first UE, a first indication of a first repetition counting procedure; means for determining the first repetition counting procedure for the first or second UE; and/or means for determining the second repetition counting procedure for the first or second UE, but not limited to the instructions stored in the computer-readable storage medium 606, or any other suitable apparatus or means described in any one of the FIGS. 1, 2, and/or 5, and utilizing, for example, the processes and/or algorithms described herein in relation to FIGS. 5, 12, and/or 13. In one aspect, the aforementioned means may be the processor(s) 604 shown in FIG. 6 configured to perform the functions recited by the aforementioned means. In another aspect, the aforementioned means may be a circuit or any apparatus configured to perform the functions recited by the aforementioned means.

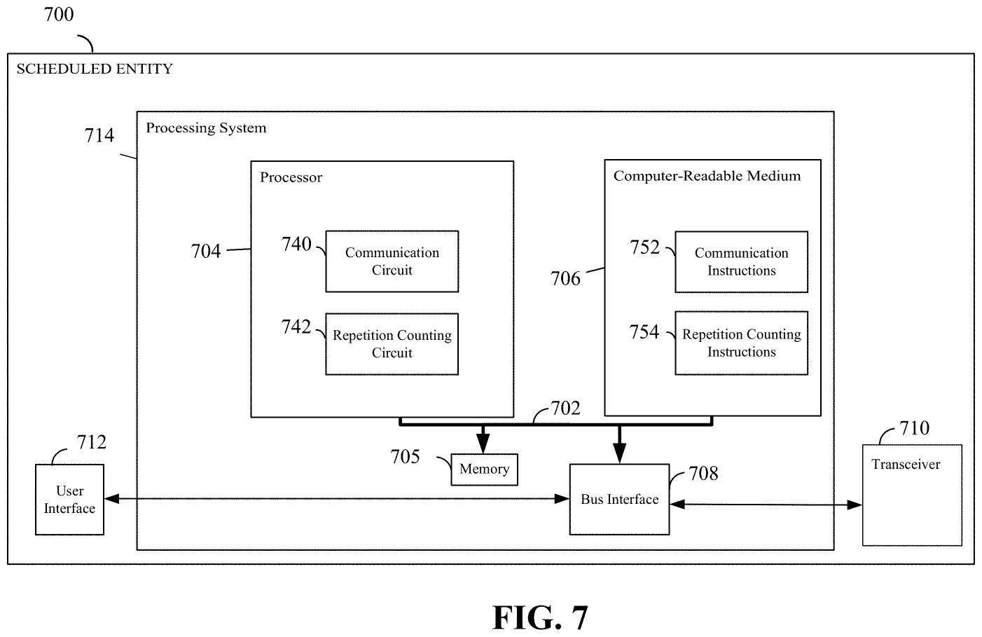

FIG. 7 is a conceptual diagram illustrating an example of a hardware implementation for an exemplary scheduled entity 700 employing a processing system 714. In accordance with various aspects of the disclosure, an element, or any portion of an element, or any combination of elements may be implemented with a processing system 714 that includes one or more processors 704. For example, the scheduled entity 700 may be a user equipment (UE) as illustrated in any one or more of FIGS. 1, 2, 4, 5, and/or 10.

The processing system 714 may be substantially the same as the processing system 814 illustrated in FIG. 8, including a bus interface 708, a bus 702, memory 706, a processor 704, and a computer-readable medium 706. Furthermore, the scheduled entity 700 may include a user interface 712 and a transceiver 710 substantially similar to those described above in FIG. 8. That is, the processor 704, as utilized in a scheduled entity 700, may be configured (e.g., in coordination with the memory 705) to implement any one or more of the processes described below and illustrated in FIGS. 5 and/or 8.

In some aspects of the disclosure, the processor 704 may include communication circuitry 740 configured (e.g., in coordination with the memory 705) for various functions, including, e.g., receiving an indication of a repetition count from a scheduling entity; receiving a resource allocation for a set of a plurality of slots on a first carrier, the first carrier paired with a second carrier and separated from the second carrier in frequency; transmitting repetitions of an uplink transmission on a subset of the plurality of slots on the first carrier; and/or receiving an indication of a repetition counting procedure for counting of the quantity of repetitions. For example, the communication circuitry 740 may be configured to implement one or more of the functions described below in relation to blocks 802, 804, 806, and/or 808 of FIG. 8. The processor 704 can further include repetition counting circuit 742 for counting repetitions of an uplink transmission based on a first or second repetition counting procedure. For example, the communication circuitry 740 may be configured to implement one or more of the functions described below in relation to blocks 806 and/or 808 of FIG. 8.

As shown in FIG. 7, the computer-readable storage medium 706 can include communication instructions 752 for instructing, appropriately, the communication instructions 752 for receiving an indication of a repetition count from a scheduling entity; receiving a resource allocation for a set of a plurality of slots on a first carrier, the first carrier paired with a second carrier and separated from the second carrier in frequency; transmitting repetitions of an uplink transmission on a subset of the plurality of slots on the first carrier; and/or receiving an indication of a repetition counting procedure for counting of the quantity of repetitions. The computer-readable storage medium 706 can also include repetition counting determination instructions 754 for counting repetitions of an uplink transmission based on a first or second repetition counting procedure.

In one configuration, the UE 700 includes means for receiving an indication of a repetition count from a scheduling entity; means for receiving a resource allocation for a set of a plurality of slots on a first carrier, the first carrier paired with a second carrier and separated from the second carrier in frequency; means for transmitting repetitions of an uplink transmission on a subset of the plurality of slots on the first carrier; means for receiving an indication of a repetition counting procedure for counting of the quantity of repetitions; and/or means for counting repetitions of an uplink transmission based on a first or second repetition counting procedure. In one aspect, the aforementioned means may be the processor(s) 704 shown in FIG. 7 configured to perform the functions recited by the aforementioned means. In another aspect, the aforementioned means may be a circuit or any apparatus configured to perform the functions recited by the aforementioned means.

Of course, in the above examples, the circuitry included in the processor 704 is merely provided as an example, and other means for carrying out the described functions may be included within various aspects of the present disclosure, including but not limited to the instructions stored in the computer-readable storage medium 706, or any other suitable apparatus or means described in any one of the processes and/or algorithms described herein in relation to FIGS. 5, 8, 11, and/or 12.

FIG. 8 illustrates a flow chart 800 illustrating an exemplary process of a user equipment (UE) for an uplink transmission based on PUSCH repetition counting according to some aspects of the disclosure. As described below, some or all illustrated features may be omitted in a particular implementation within the scope of the present disclosure, and some illustrated features may not be required for implementation of all features. In some examples, the process may be carried out by a UE, such as by UE 501, the UE 502, the scheduled entity 700, or another scheduled entity described herein. However, it should be appreciated that the process may be carried out by any suitable apparatus or means for carrying out the functions or algorithm described below. For example, the process may be carried out by a scheduling entity (e.g., a base station, a UE, or any other suitable device to schedule resources).

At block 802, a UE may receive an indication of a repetition count from a scheduling entity. For example, with reference to FIG. 5, the UE 501 may receive the indication of the repetition count from the scheduling entity 503. The repetition count may indicate a number of repetitions of a transport block (TB) that the UE should transmit to the scheduling entity. In some examples, the repetitions are to be transmitted by the first UE to the scheduling entity on respective slots, with each repetition being included in the same symbol location in each of the respective slots, as described herein with respect to Type A repetitions. The indication of the repetition count may be a number, symbol, or any other suitable indication to indicate the repetition count. For example, the indication of the first repetition count may be the actual number of repetitions of a TB. For example, the scheduling entity may transmit a ‘3’ for three repetitions of a TB in an uplink transmission. In other examples, the scheduling entity may transmit a signal indicative of the repetition count. For example, a bit within a control message transmitted by the scheduling entity may be set to 0 to indicate a first number of repetitions and may be set to 1 to indicate a second number of repetitions. In some aspects, the scheduling entity may transmit the indication of the repetition count through a random access response (RAR) message, a radio resource control (RRC) message, a medium access control (MAC) control element (MAC-CE) message, a downlink control information (DCI) message, or any other suitable message as well.

At block 804, the UE may receive a resource allocation for a set of a plurality of slots on a first carrier. In some examples, a slot may be defined according to a specified number of OFDM symbols with a given cyclic prefix (CP) length. Here, the first carrier may be paired with a second carrier and separated from the second carrier in frequency. In other words, the first resource allocation may provide a paired spectrum allocation to the first UE, such as described further below. Additionally, the first UE may be configured to operate in half-duplex communication, such as described further below. As an example, in block 804, the UE 501 may receive the resource allocation from the scheduling entity 503.

In some examples, a slot may include 7 or 14 OFDM symbols with a nominal CP. Additional examples may include mini-slots having a shorter duration (e.g., 1, 2, 4, or 7 OFDM symbols). These mini-slots may in some cases be transmitted occupying resources scheduled for ongoing slot transmissions for the same or for different UEs. In other examples, a slot may include another number of symbols and/or may correspond to any suitable duration of time, and may correspond to other nomenclature such as a transmission time interval (TTI), subframe, frame, symbol duration, etc.

As noted above, the first carrier may be paired with a second carrier and separated from the second carrier in frequency. In other words, the first carrier may include frequency blocks or resources that do not overlap with the frequency blocks or resources of the second carrier. Additionally, the first carrier may, for example, be paired with an inter-band or an intra-band carrier (e.g., the second carrier). That is, the first carrier and the second carrier may belong to the same operating frequency band or different operating frequency bands.

In some examples, the resource allocation may be for frequency division duplex (FDD) communication over the first and second carriers. However, in some examples, the resource allocation may be for time division duplex (TDD) communication over the first and second carriers. In other examples, the resource allocation may be for FDD communication over the first carrier and TDD communication over the second carrier, or vice-versa.

In some examples, the first carrier may be paired with the second carrier such that one or more frequency blocks or resources in the first carrier are allocated or used for one communication direction (downlink or uplink) while one or more frequency blocks or resources in the second carrier are allocated or used for the opposite communication direction (uplink or downlink).

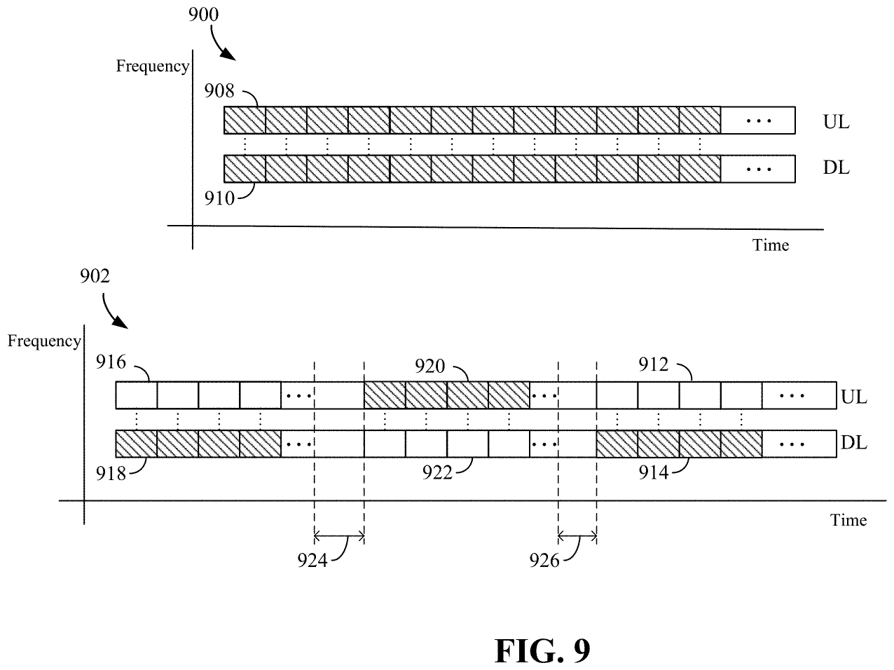

Additionally, as noted, the UE may operate in half duplex communication. For example, in half duplex communication, the UE may only transmit a signal or may only receive a signal at a particular time. FIG. 9 shows a conceptual illustration of a full duplex operation 900 with a paired spectrum and a half duplex operation 902 with a paired spectrum according to some aspects of the disclosure. In this illustration, a first carrier 904, 912 (e.g., component carrier 1 or CC1) is paired with a second carrier 906, 914 (e.g., component carrier 2 or CC2). The horizontal axis represents time, and the vertical axis represents frequency (not to scale). In this example, the first carrier 904, 912 and the second carrier 906, 914 are FDD carriers. The first carrier 904, 912 is paired with the second carrier 906, 914 such that an uplink slot 908, 916 corresponds to a downlink slot 910, 918 in an opposite communication direction on the same time slot but different frequency bands.

In a full duplex operation 900, the UE may perform bidirectional communication with the scheduling entity on the same time slot 908, 910. For example, the UE may transmit a signal on an uplink slot 908 and at the same time receive a signal from the scheduling entity on a corresponding downlink slot 910. On the other hand, in a half duplex communication, as explained above, the UE may not transmit and receive a signal simultaneously on the same time slot. For example, the UE may not transmit a signal on an uplink slot 916 when the UE receives a signal on a corresponding downlink slot 918. Similarly, the UE may not receive a signal on a downlink slot 922 when the UE transmits a signal on a corresponding uplink slot 920. In some examples of the half duplex communication, one or more guard symbols 924, 926 are used when a communication direction changes. For example, after the UE receives a signal on a downlink slot, guard symbols 924 may exist to introduce a delay between uplink and downlink communications and, thereby, reduce interference between uplink and downlink communications before the UE transmits a signal on an uplink slot 920. Similarly, after the UE transmits a signal on an uplink slot 920, guard symbols 926 may exist to introduce delay and reduce interference between uplink and downlink communications before the UE receives a signal on a downlink slot.

Returning to FIG. 8, at optional block 806, the UE may receive an indication of a repetition counting procedure for counting of the quantity of repetitions. A repetition counting procedure enables a device (e.g., a UE or scheduling entity) to count the number or quantity of repetitions of a communication (e.g., a TB) that have been transmitted (or received), or to count the number or quantity of slots (or symbols or another unit of measure) that have occurred since repetitions of the communication began. In some examples, a UE may be configured to implement multiple different repetition counting procedures. In these examples, the UE may select a particular repetition counting procedure based on the indication of the repetition counting procedure received in optional block 806. The indication may be received from the scheduling entity. For example, with reference to FIG. 5, the scheduling entity 503 may provide the indication of the repetition counting procedure to the UE 501 (or UE 502).

As explained above, the quantity of repetitions or the actual number of repetitions may not be the same as the repetition count received from the scheduling entity. As noted, the block 806 is optional. That is, in some examples, this block 806 is bypassed or not present, and the UE does not receive the indication of the repetition counting procedure. In these examples, for instance, a repetition counting procedure can be fixedly associated with the first UE. That is, the UE may not have multiple repetition counting procedures from which to choose to implement. In other examples, the UE may already be aware of the repetition counting procedure because, for example, the UE may have been programmed at the time of manufacture or through a firmware update to use the particular repetition counting procedure. In some examples, the UE may have the repetition counting procedure stored in a memory (e.g., the memory 705).

FIGS. 10A, 10B, 11A, and 11C provide conceptual illustrations of examples of different repetition counting procedures. FIG. 10A is a conceptual illustration of a first repetition counting procedure 1000 used for time division duplex (TDD) communications between a scheduled entity (e.g., a UE) and a scheduling entity (e.g., a base station) with an unpaired spectrum where uplink and downlink communications share the same frequency carrier or spectrum. In other words, with an unpaired spectrum, uplink and downlink communications occur on the same or overlapping frequency resources. FIG. 10A illustrates a plurality of slots 1001, each represented as a square in the top row of FIG. 10A. The slots 1001 represents slots in the shared spectrum, and the horizontal axis 1002 represents time. Because the communications occur using TDD, the UE either receives or transmits in a given slot. Among the slots illustrated, the UE may transmit five repetitions: repetition 1004a, repetition 1004b, repetition 1004c, repetition 1004d, and repetition 1004e. In the counting procedure 1000, the UE may count consecutive slots starting from a first repetition 1004a of the uplink transmission. That is, each consecutive slot is counted regardless of whether it is an uplink slot (“U”), a downlink slot (“D), or a special slot “(S”), and regardless of whether a repetition is actually transmitted within the slot. Illustrated below the slots 1001 is a repetition counter row 1006 showing the value of a repetition counter as it counts according to the repetition counting procedure 1000 over time. Because, in the first counting procedure 1000, consecutive slots are counted regardless of whether the slots are uplink, downlink, or special, and regardless of whether an actual repetition is transmitted on the slots, a repetition count indicated by a scheduling entity and the ending value of the repetition counter row 1006 may not be the same as the quantity of repetitions actually transmitted by the UE. For example, in the example of FIG. 10A, the indicated repetition count is sixteen (16), the ending value of the repetition counter row 1006 is sixteen (16), and the quantity of repetitions actually transmitted by the UE is five (5).

FIG. 10B is a conceptual illustration of a second repetition counting procedure 1050 used for frequency division duplex (FDD) communications between a scheduled entity (e.g., a UE) and a scheduling entity (e.g., a base station) with a paired spectrum, where uplink and downlink communications do not share the same frequency carrier or spectrum. FIG. 10B illustrates a plurality of uplink slots 1051a and a plurality of downlink slots 1051b, each represented as a square. The slots 1051a and 1051b represents slots in the paired spectrum, and the horizontal axis 1052 represents time. Because the communications occur using FDD, the UE may both receive and transmit at the same time. Among the slots illustrated, the UE may transmit sixteen repetitions in consecutive slots of the uplink slots 1051a, the first of which is illustrated as repetition 1054a and the last of which is illustrated as repetition 1054b. In the counting procedure 1050, the UE may count consecutive slots starting from a first repetition 1004a of the uplink transmission. Illustrated below the slots 1051a is a repetition counter row 1056 showing the value of a repetition counter as it counts according to the repetition counting procedure 1050 over time. In the FDD communications using a paired spectrum, a repetition count indicated by a scheduling entity and the ending value of the repetition counter row 1056 may be the same as the quantity of repetitions actually transmitted by the UE. For example, in the example of FIG. 10B, the indicated repetition count is sixteen (16), the ending value of the repetition counter row 1006 is sixteen (16), and the quantity of repetitions actually transmitted by the UE is sixteen (16).

FIG. 11A is a conceptual illustration of a repetition counting procedure 1100 (also referred to a first repetition counting procedure) used for half duplex communications between a scheduled entity (e.g., a UE) and a scheduling entity (e.g., a base station) with a paired spectrum where uplink and downlink communications do not share the same frequency carrier or spectrum. For example, under this first repetition counting procedure 1100, the quantity of repetitions transmitted may be based on a count of consecutive slots (e.g., regardless of whether the slots are uplink, downlink, or special slots) of the set of the plurality of slots from a first repetition of the uplink transmission until the count reaches the repetition count. In this illustration, a horizontal axis 1104 represents time, and a (first) uplink carrier 1106 is paired with a (second) downlink carrier 1108. Additionally, the uplink carrier 1106 and the downlink carrier 1108 carry FDD communications, and the UE operates in half duplex communication. Illustrated below the slots of the uplink carrier 1106 is a repetition counter row 1112 showing the value of a repetition counter as it counts according to the repetition counting procedure 1100 over time. In the counting procedure 1100, the UE may start counting each consecutive slot from a first repetition 1114 of the uplink transmission. That is, each consecutive slot is counted regardless of whether it is an uplink slot (“U”), a downlink slot (“D), or a special slot “(S”), and regardless of whether a repetition is actually transmitted within the slot.

In the example of FIG. 11A, the UE may have determined that the repetition count is sixteen (16) based on the indication of the repetition count received in block 802. Then, in operation, the UE counts sixteen (16) consecutive slots (including uplink, downlink, and special slots) starting at the slot of repetition 1114, as shown by the incrementing the value of the repetition counter row 1112 over time from 0 to 15. Among sixteen (16) counted slots, the UE may transmit repetitions of a TB on five available uplink slots (repetition 0 (1014), repetition 5 (1016), repetition 6 (1018), repetition 10 (1020), repetition 15 (1022)).

In some scenarios, a repetition may be suitable only for an uplink slot because (a) downlink slots may not be used for uplink communications and (b) special slots may not provide consistency that is relied upon for certain repetitions. For example, for PUSCH repetition Type A, the starting symbol for the repetition may be the first symbol (symbol 0) of a slot. In this scenario, the UE does not select a special slot for a repetition because the first symbol may not be available for an uplink transmission (with a repetition or otherwise). However, in other scenarios, a repetition may be suitable for transmission on both an uplink and special slot. Because, in the first counting procedure 1100, slots are counted regardless of whether the slots are uplink, downlink, or special, and regardless of whether an actual repetition is transmitted on the slots, the repetition count indicated by the scheduling entity (in block 802) and the ending value of the repetition counter row 1112 may not be the same as the quantity of repetitions actually transmitted by the UE. For example, in the example of FIG. 11A, the indicated repetition count is sixteen (16), the ending value of the repetition counter 1012 is sixteen (16), and the quantity of repetitions actually transmitted by the UE is five (5).

FIG. 11B is a conceptual illustration of a repetition counting procedure 1150 (also referred to a second repetition counting procedure) used for half duplex communications between a scheduled entity (e.g., a UE) and a scheduling entity (e.g., a base station) with a paired spectrum where uplink and downlink communications do not share the same frequency carrier or spectrum. For example, under the repetition counting procedure 1150, the quantity of repetitions transmitted may be based on a count of available uplink slots of the set of the plurality of slots from a first repetition of the uplink transmission until the count reaches the repetition count. Here, the repetition count from the scheduling entity may be the same as the quantity of the repetitions transmitted in one or more transmissions because the repetition count corresponds to the number of available uplink slots. In this illustration, a horizontal axis 1154 represents time, and a (first) uplink carrier 1156 is paired with a (second) downlink carrier 1158. Additionally, the uplink carrier 1156 and the downlink carrier 1158 carry FDD communications, and the UE operates in half duplex communication. Illustrated below the slots of the uplink carrier 1156 is a repetition counter row 1152 showing the value of a repetition counter as it counts according to the repetition counting procedure 1150 over time.

In the counting procedure 1150, the UE may start counting each available uplink slot from a first repetition 1160 of the uplink transmission. That is, each uplink slot (“U”) is counted (and, thus, the value of the repetition counter row 1152 increments), while the downlink (“D”) and special (“S”) slots are not counted (and, thus, the value of the repetition counter row 1152 does not increment).

In the example of FIG. 11B, the UE may have determined that the repetition count is five (5) based on the indication of the repetition count received in block 802. Then, in operation, the UE counts five (5) available uplink slots and transmits five repetitions of a TB (repetition 0 (1160), repetition 1 (1162), repetition 2 (1164), repetition 3 (1166), repetition 4 (1168)). Since the available uplink slots for repetitions is the same as the repetition count received from the scheduling entity, under the second repetition counting procedure, the repetition count indicated by the scheduling entity may be the same as the quantity of repetitions that are transmitted in a uplink transmission.

Returning to FIG. 8, at block 808, the UE may transmit repetitions of an uplink transmission on a subset of the plurality of slots on the first carrier. A quantity of the repetitions transmitted may be based on the repetition count. In some examples, each repetition of the TB may indicate the same TB while the way the TB of a repetition is expressed on the symbol(s) at the same location of a respective slot may be different from another repetition of the TB (e.g., based on code rate, scrambling, modulation scheme, layer mapping, etc.). The repetitions of the TB may correspond to physical uplink shared channels (PUSCHs) of slots. Each repetition of the TB corresponding to a respective slot may correspond to the same symbol location of the respective slot. In some examples, the repetitions may be Type A PUSCH repetitions. In some examples, the repetitions may be transmitted on one or more corresponding PUSCH transmissions that correspond to the subset of the plurality of slots.

As noted, the quantity of the repetitions transmitted may be based on the repetition count. For example, the UE may transmit repetitions and count repetitions using a repetition counting procedure, such as the repetition counting procedure 1100 described with respect to FIG. 11A or the repetition counting procedure 1150 described with respect to FIG. 11B. When the implemented repetition counting procedure indicates that the value of a repetition counter (e.g., indicated in the row 1112 of FIG. 11A and 1152 of FIG. 11B) has reached the repetition count indicated by the scheduling entity in block 802, the UE may determine that the UE has completed transmitting repetitions and may cease sending further repetitions (for the particular uplink communication being repeated). It should be appreciated that the examples above are mere examples that do not limit any features in the disclosure.

FIG. 12 illustrates a flow chart 1200 illustrating an exemplary process of a scheduling entity for an uplink transmission based on PUSCH repetition counting according to some aspects of the disclosure. As described below, some or all illustrated features may be omitted in a particular implementation within the scope of the present disclosure, and some illustrated features may not be required for implementation of all features. In some examples, the process may be carried out by a scheduling entity, such as the scheduling entity 503, 600, or another scheduling entity disclosed herein. However, it should be appreciated that the process may be carried out by any suitable apparatus or means for carrying out the functions or algorithm described below.

At block 1202, a scheduling entity may transmit an indication of a first repetition count to a first UE. For example, with reference to FIG. 5, the scheduling entity 503 may transmit the indication of the repetition count to the UE 501. The first repetition count may indicate a number of repetitions of a transport block (TB) that the first UE should transmit to the scheduling entity. In some examples, the repetitions are to be transmitted by the first UE to the scheduling entity on respective slots, with each repetition being included in the same symbol location in each of the respective slots, as described above with respect to Type A repetitions. The indication of the repetition count may be a number, symbol, or any other suitable indication to indicate the repetition count. For example, the indication of the first repetition count may be the actual number of repetitions of a TB. For example, the scheduling entity may transmit a ‘3’ for three repetitions of a TB in an uplink transmission. In other examples, the scheduling entity may transmit a signal indicative of the repetition count. For example, a bit within a control message transmitted by the scheduling entity may be set to 0 to indicate a first number of repetitions and may be set to a 1 to indicate a second number of repetitions. It should be appreciated that In some aspects, the scheduling entity may transmit the indication of the repetition count through a random access response (RAR) message, a radio resource control (RRC) message, a medium access control (MAC) control element (MAC-CE) message, a downlink control information (DCI) message, or any other suitable message as well.

At block 1204, the scheduling entity may transmit, to the first UE, a first resource allocation for a set of a plurality of first slots on a first carrier. Here, the first carrier may be paired with a second carrier and separated from the second carrier in frequency. In other words, the first resource allocation may provide a paired spectrum allocation to the first UE, such as described with respect to FIG. 9. Additionally, the first UE may be configured to operate in half-duplex communication, such as described above with respect to FIGS. 11A and 11B. As an example, in block 1204, the scheduling entity 503 may transmit the first resource allocation to the UE 501.

In some examples, a slot may be defined according to a specified number of OFDM symbols with a given cyclic prefix (CP) length. For example, a slot may include 7 or 14 OFDM symbols with a nominal CP. In other examples, a slot may include another number of symbols and/or may correspond to any suitable duration of time, and may correspond to other nomenclature such as a transmission time interval (TTI), subframe, frame, symbol duration, etc. Additional examples may include mini-slots having a shorter duration (e.g., 1, 2, 4, or 7 OFDM symbols). These mini-slots may in some cases be transmitted occupying resources scheduled for ongoing slot transmissions for the same or for different UEs.

In some examples, the first resource allocation may be for frequency division duplex (FDD) communication over the first and second carrier. However, in some examples, the resource allocation may be for time division duplex (TDD) communication or communication using another duplexing mode.

At block 1206, the scheduling entity may receive, from the first UE, repetitions of a first uplink transmission on a first subset of the plurality of first slots on the first carrier, wherein a first quantity of the repetitions that are received is based on the first repetition count. For example, as described above with respect to block 806, the first UE may be configured to transmit the repetitions to the scheduling entity, and the quantity of the repetitions that are received is based on the first repetition count. The scheduling entity, like the UE in block 806, may be configured to count the received repetitions. Further, like the UE in block 806, the scheduling entity may use different counting procedures, such as the counting procedure described with respect to FIG. 11A or the counting procedure described with respect to FIG. 11B. In particular, the scheduling entity may use the same counting procedure that is used by the first UE that is transmitting the repetitions. In this way, the scheduling entity can receive and process the repetitions, and determine when each of the repetitions has been received and/or the first UE has completed transmitting repetitions.

As an example, the counting procedure used by the scheduling entity to count repetitions from the first UE may correspond to (i) the quantity of repetitions transmitted (and received by the scheduling entity) being based on a count of uplink and downlink slots of the set of the plurality of slots from a first repetition of the uplink transmission until the count reaches the repetition count, or (ii) the quantity of repetitions transmitted (and received by the scheduling entity) being based on a count of available uplink slots of the set of the plurality of slots from a first repetition of the uplink transmission until the count reaches the repetition count.

The scheduling entity may be aware of the counting procedure being used by the first UE because, for example, the scheduling entity may have previously transmitted to the first UE an indication of the counting procedure to be used by the first UE (e.g., in a configuration step), or because the counting procedure being used by the first UE is fixed. In the case that the counting procedure used by the first UE is fixed, the scheduling entity may receive an indication from the first UE of the counting procedure being used or the scheduling entity may use other identifying information from the first UE to access a memory that indicates which counting procedure is associated the that identifying information.

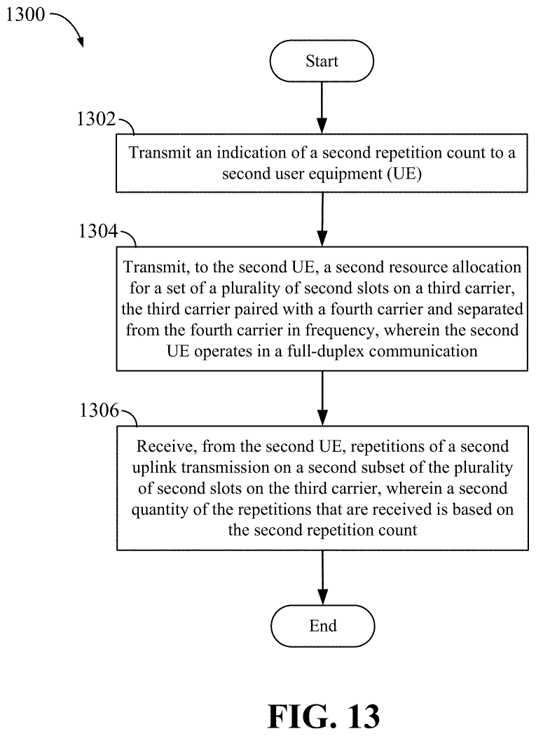

FIG. 13 illustrates another flow chart 1300 illustrating an exemplary process of a scheduling entity for an uplink transmission based on PUSCH repetition counting according to some aspects of the disclosure. As described below, some or all illustrated features may be omitted in a particular implementation within the scope of the present disclosure, and some illustrated features may not be required for implementation of all features. In some examples, the process may be carried out by a scheduling entity, such as the scheduling entity 503, 600, or another scheduling entity disclosed herein. However, it should be appreciated that the process may be carried out by any suitable apparatus or means for carrying out the functions or algorithm described below.

In some examples, the scheduling entity that performed the flow chart 1200 of FIG. 12 also performs the flow chart 1300. For example, the scheduling entity may perform the flow charts 1200 and 1300 in parallel, partially in parallel, or in series (e.g., the flow chart 1200 executed before or after the flow chart 1300). Furthermore, over the course of communications with first and second UEs, the scheduling entity may execute the flow charts 1200 and/or 1300 a plurality of times. For clarity, in view of the potential for the scheduling entity to perform both flow charts 1200 and 1300, the flow chart 1200 is described with respect to a first UE, first repetition count, first resource allocation, first and second carriers, etc., while the flow chart 1300 is described with respect to a second UE, second repetition count, second resource allocation, third and fourth carriers, etc. However, despite this naming convention, in some examples, the scheduling entity may perform just the flow chart 1200 (i.e., without performing the flow chart 1300), or may perform just the flow chart 1300 (i.e., without performing the flow chart 1200).

Turning to FIG. 13, at block 1302, a scheduling entity may transmit an indication of a second repetition count to a second UE. For example, with reference to FIG. 5, the scheduling entity 503 may transmit the indication of the second repetition count to the UE 502. The second repetition count may indicate a number of repetitions of a transport block (TB) that the second UE should transmit to the scheduling entity. In some examples, the repetitions are to be transmitted by the second UE to the scheduling entity on respective slots, with each repetition being included in the same symbol location in each of the respective slots, as described above with respect to Type A repetitions. As described with respect to the indication of the first repetition count in block 1202, the indication of the second repetition count may be a number, symbol, or any other suitable indication to indicate the repetition count. Further, it should be appreciated that In some aspects, the scheduling entity may transmit the indication of the second repetition count through a random access response (RAR) message, a radio resource control (RRC) message, a medium access control (MAC) control element (MAC-CE) message, a downlink control information (DCI) message, or any other suitable message as well.

At block 1204, the scheduling entity may transmit, to the second UE, a second resource allocation for a set of a plurality of second slots on a third carrier. Here, the third carrier may be paired with a fourth carrier and separated from the fourth carrier in frequency. In other words, the resource allocation may provide a paired spectrum allocation to the second UE, such as described with respect to FIG. 9. Additionally, the second UE may be configured to operate in full-duplex communication, such as described above with respect to FIG. 9. As an example, in block 1304, the scheduling entity 503 may transmit the resource allocation to the UE 502.

In some examples, a slot may be defined according to a specified number of OFDM symbols with a given cyclic prefix (CP) length. For example, a slot may include 7 or 14 OFDM symbols with a nominal CP. In other examples, slots may have a different number of OFDM symbols. Additional examples may include mini-slots having a shorter duration (e.g., 1, 2, 4, or 7 OFDM symbols). These mini-slots may in some cases be transmitted occupying resources scheduled for ongoing slot transmissions for the same or for different UEs.

In some examples, the resource allocation may be for frequency division duplex (FDD) communication over the first and second carrier. However, in some examples, the resource allocation may be for time division duplex (TDD) communication or communication using another duplexing mode.

At block 1306, the scheduling entity may receive, from the second UE, repetitions of a second uplink transmission on a second subset of the plurality of second slots on the third carrier, wherein a second quantity of the repetitions that are received is based on the second repetition count. For example, as described above with respect to block 806, the second UE may be configured to transmit the repetitions, wherein the quantity of the repetitions that are received is based on the second repetition count. The scheduling entity, like the UE in block 806, may be configured to count the received repetitions. Further, like the UE in block 806, the scheduling entity may use different counting procedures, such as the counting procedure described with respect to FIG. 11A or the counting procedure described with respect to FIG. 11B. In particular, the scheduling entity may use the same counting procedure that is used by the second UE that is transmitting the repetitions. In this way, the scheduling entity can receive and process the repetitions, and determine when each of the repetitions has been received and/or the second UE has completed transmitting repetitions. The scheduling entity may be aware of the counting procedure being used by the second UE because, for example, the scheduling entity may have previously transmitted to the second UE an indication of the counting procedure to be used by the second UE (e.g., in a configuration step), or because the counting procedure being used by the second UE is fixed. In the case that the counting procedure used by the second UE is fixed, the scheduling entity may receive an indication from the second UE of the counting procedure being used or the scheduling entity may use other identifying information from the second UE to access a memory that indicates which counting procedure is associated the that identifying information.

In some examples where the flowcharts 1200 and 1300 are performed by the scheduling entity, the repetitions of the first uplink transmission are associated with a first repetition counting procedure and the repetitions of the second uplink transmission are associated with a second repetition counting procedure. For example, for the first repetition counting procedure, the quantity of repetitions transmitted is based on a count of available uplink slots of the set of the plurality of slots from a first repetition of the uplink transmission until the count reaches the repetition count. As another example, for the second repetition counting procedure, the quantity of repetitions transmitted is based on a count of uplink and downlink slots of the set of the plurality of slots from a first repetition of the uplink transmission until the count reaches the repetition count. An example of such a first repetition counting procedure is described with respect to FIG. 11A, and an example of such a second repetition counting procedure is described with respect to FIG. 11B. In other examples, both the first and second repetition counting procedures are as described with respect to FIG. 11A, or as described with to FIG. 11B. In yet further examples, the first repetition counting procedure is as described with respect to FIG. 11B, and the second repetition counting procedure is as described with respect to FIG. 11A.

In some examples where the flowcharts 1200 and 1300 are performed by the scheduling entity, the scheduling entity further transmits, to the first UE, a first indication of the first repetition counting procedure. Additionally or alternatively, the scheduling entity may further transmit, to the second UE, a second indication of the second repetition counting procedure. Further, it should be appreciated that, in some aspects, the scheduling entity may transmit the first indication and/or second indication through one or more of a random access response (RAR) message, a radio resource control (RRC) message, a medium access control (MAC) control element (MAC-CE) message, a downlink control information (DCI) message, or any other suitable message as well.

In some examples where the flowcharts 1200 and 1300 are performed by the scheduling entity, the first repetition counting procedure is fixedly associated with the first UE. Additionally or alternatively, the second repetition counting procedure may be fixedly associated with the second UE. In other words, the particular repetition counting procedures may not be configured by signaling from the scheduling unit. Rather, the respective repetition counting procedures, in these examples, may be hard coded into the first UE and second UE.

In some examples where the flowcharts 1200 and 1300 are performed by the scheduling entity, the scheduling entity further transmits, to the first UE, a first indication of the first repetition counting procedure, and the second repetition counting procedure is fixedly associated with the second UE.

In some examples where the flowcharts 1200 and 1300 are performed by the scheduling entity, the scheduling entity further transmits, to the second UE, a second indication of the second repetition counting procedure, and the first repetition counting procedure is fixedly associated with the first UE.

### Collision Handling for Half-Duplex Operation in Paired Spectrum

In some examples, one of the above-described systems (e.g., system 500 of FIG. 5) implements collision handling for half-duplex, paired spectrum operation. For example, when a UE (e.g., UE 502 of FIG. 5) operates in half-duplex mode in an FDD band (e.g., communicates with the scheduling entity 503 in half-duplex using FDD on an allocated bandwidth), then downlink reception in the downlink carrier can conflict with uplink transmission in the uplink carrier. For example, communication systems (e.g., the system 500) can use preconfigured downlink transmission, for example, SSB or broadcast signals (e.g., for SI or paging), and dynamically scheduled or configured uplink transmission (e.g., signals or channels (e.g., PRACH)). In some instances, a dynamically scheduled uplink transmission may overlap in time with a preconfigured downlink transmission. Presently, such uplink and downlink communications are not considered an overlap or collision because the paired spectrum allocation results in uplink transmission from the UE on a different carrier (e.g., different frequency resources) than downlink transmission to the UE. As a result, collision handling is not used to mitigate the conflict or interference between the uplink and downlink transmissions over the paired spectrum.

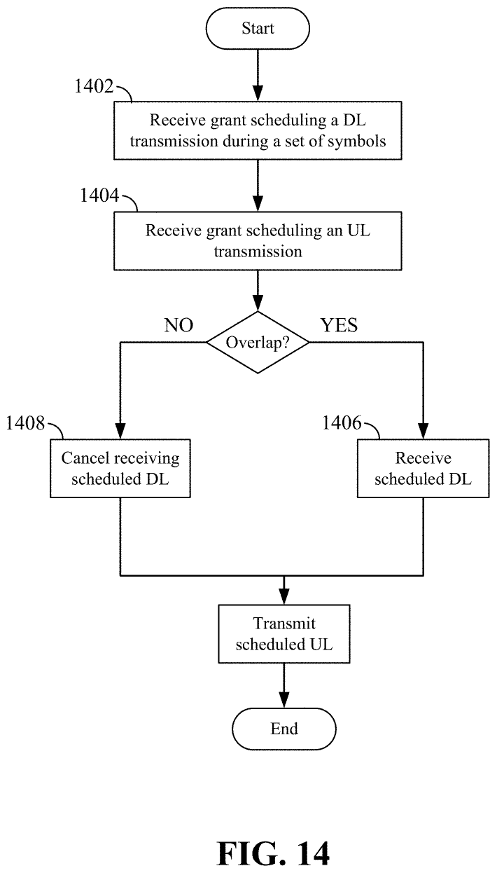

In some examples, to account for and mitigate the above-described conflict and interference, when downlink reception of channels/signals overlap in time with uplink transmission of channels/signals for a UE operating in half duplex mode in a paired spectrum, the collision handling rules typically used for unpaired spectrum are used to resolve the collision. For example, FIG. 14 illustrates an exemplary process for a UE operating in half duplex mode that is configured to receive a downlink transmission, which receives a DCI scheduling an uplink transmission that overlaps in time with at least a portion of the scheduled downlink transmission. For example, at block 1402, a UE operating in half duplex mode receives a grant (e.g., DCI) scheduling a downlink transmission during a set of symbols. At block 1404, the UE receives a grant (e.g., DCI) scheduling an uplink transmission. If the scheduled uplink transmission does not overlap with the scheduled downlink transmission, then at block 1406 the UE may receive the scheduled downlink transmission. However, if the scheduled uplink transmission overlaps with at least a portion of the scheduled downlink transmission, then at block 1408 the UE may cancel receiving the scheduled downlink transmission, and at block 1410 the UE may transmit the scheduled uplink transmission. That is, in this case, the UE may transmit the scheduled uplink and may not receive the overlapping downlink transmission.

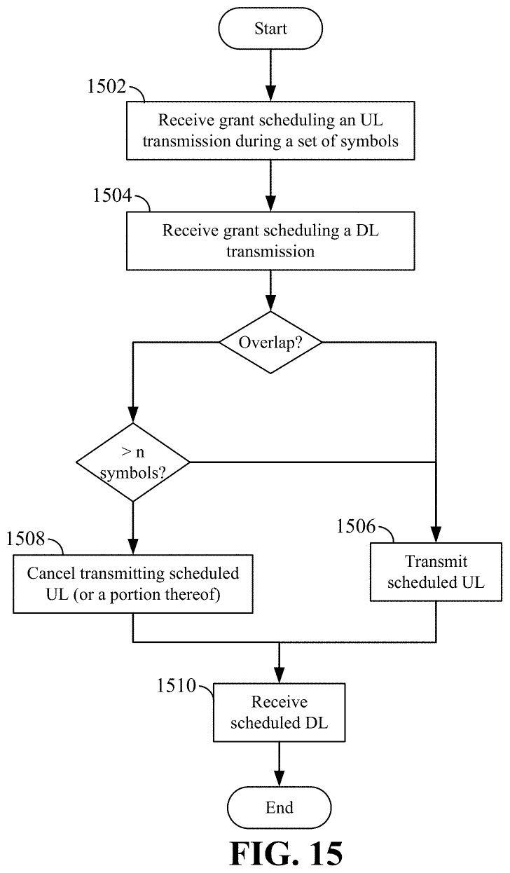

FIG. 15 illustrates another example, corresponding to a UE operating in half duplex mode that is configured to transmit an uplink transmission, which receives a DCI scheduling a downlink transmission that overlaps in time with at least a portion of the scheduled uplink transmission. For example, at block 1502, a UE operating in half duplex mode receives a grant (e.g., DCI) scheduling an uplink transmission during a set of symbols. At block 1504, the UE receives a grant (e.g., DCI) scheduling a downlink transmission. If the scheduled downlink transmission does not overlap with the scheduled uplink transmission, then at block 1506 the UE may transmit the scheduled uplink transmission. However, in the case where the downlink grant overlaps in time with at least a portion of the scheduled uplink transmission, in some examples, at block 1508 the UE may cancel the uplink transmission (and/or a repetition of the uplink transmission) if the DCI scheduling the downlink transmission is greater than a suitable number n of symbols before the scheduled uplink transmission. In other examples, the UE may cancel the portion of the uplink transmission (and/or a repetition of the uplink transmission) that is scheduled for greater than a suitable number n of symbols after receiving the DCI scheduling the downlink transmission. And, at block 1510, the UE may receive the scheduled downlink transmission.

### Further Examples Having a Variety of Features:

Example 1: A method, apparatus, and non-transitory computer-readable medium operable at a scheduling entity for transmitting an indication of a first repetition count to a first user equipment (UE); transmitting, to the first UE, a first resource allocation for a set of a plurality of first slots on a first carrier, the first carrier paired with a second carrier and separated from the second carrier in frequency, wherein the first UE operates in a half-duplex communication; and receiving, from the first UE, repetitions of a first uplink transmission on a first subset of the plurality of first slots on the first carrier, wherein a first quantity of the repetitions that are received is based on the first repetition count.

Example 2. The method, apparatus, and non-transitory computer-readable medium of Example 1, further comprising: transmitting an indication of a second repetition count to a second UE; transmitting, to the second UE, a second resource allocation for a set of a plurality of second slots on a third carrier, the third carrier paired with a fourth carrier and separated from the fourth carrier in frequency, wherein the first UE operates in a full-duplex communication; and receiving, from the second UE, repetitions of a second uplink transmission on a second subset of the plurality of second slots on the third carrier, wherein a second quantity of the repetitions of the second uplink transmission that are received is based on the first repetition count.

Example 3. The method, apparatus, and non-transitory computer-readable medium of any of Examples 1 to 2, wherein the repetitions of the first uplink transmission are associated with a first repetition counting procedure and the repetitions of the second uplink transmission are associated with a second repetition counting procedure.

Example 4. The method, apparatus, and non-transitory computer-readable medium of Example 3, wherein, for the first repetition counting procedure, the first quantity of the repetitions transmitted is based on a count of available uplink slots of the set of the plurality of first slots from a first repetition of the first uplink transmission until the count reaches the first repetition count.

Example 5. The method, apparatus, and non-transitory computer-readable medium of any of Examples 1 to 4, wherein for the second repetition counting procedure, the quantity of the repetitions transmitted is based on a count of uplink and downlink slots of the set of the plurality of second slots from a first repetition of the second uplink transmission until the count reaches the second repetition count.

Example 6. The method, apparatus, and non-transitory computer-readable medium of any of Examples 1 to 5, further comprising: transmitting, to the first UE, a first indication of the first repetition counting procedure; and transmitting, to the second UE, a second indication of the second repetition counting procedure.

Example 7. The method, apparatus, and non-transitory computer-readable medium of any of Examples 1 to 6, wherein the first repetition counting procedure is fixedly associated with the first UE and wherein the second repetition counting procedure is fixedly associated with the second UE.

Example 8. The method, apparatus, and non-transitory computer-readable medium of any of Examples 1 to 7, further comprising: transmitting, to the first UE, a first indication of the first repetition counting procedure, and wherein the second repetition counting procedure is fixedly associated with the second UE.

Example 9. The method, apparatus, and non-transitory computer-readable medium of any of Examples 1 to 8, further comprising: transmitting, to the second UE, a second indication of the second repetition counting procedure, and wherein the first repetition counting procedure is fixedly associated with the first UE.

Example 10. The method, apparatus, and non-transitory computer-readable medium of any of Examples 1 to 9, further comprising: transmitting, to the first UE, a first indication of a first repetition counting procedure, wherein the repetitions of the first uplink transmission are associated with the first repetition counting procedure.

Example 11. The method, apparatus, and non-transitory computer-readable medium of any of Examples 1 to 10, wherein, for the first repetition counting procedure: (i) the first quantity of the repetitions transmitted is based on a count of uplink and downlink slots of the set of the plurality of first slots from a first repetition of the first uplink transmission until the count reaches the first repetition count, or (ii) the first quantity of the repetitions transmitted is based on a count of available uplink slots of the set of the plurality of first slots from a first repetition of the first uplink transmission until the count reaches the repetition count.

Example 12. A method, apparatus, and non-transitory computer-readable medium operable at a user equipment (UE), comprising: receiving an indication of a repetition count from a scheduling entity; receiving a resource allocation for a set of a plurality of slots on a first carrier, the first carrier paired with a second carrier and separated from the second carrier in frequency wherein the UE operates in a half duplex communication; and transmitting repetitions of an uplink transmission on a subset of the plurality of slots on the first carrier, wherein a quantity of the repetitions transmitted is based on the repetition count.

Example 13. The method, apparatus, and non-transitory computer-readable medium of Example 12, further comprising: receiving an indication of a repetition counting procedure for counting of the quantity of the repetitions.

Example 14. The method, apparatus, and non-transitory computer-readable medium of any of Examples 12 to 13, wherein the quantity of the repetitions transmitted is based on a count of available uplink slots of the set of the plurality of slots from a first repetition of the uplink transmission until the count reaches the repetition count.

Example 15. The method, apparatus, and non-transitory computer-readable medium of any of Examples 1 to 14, wherein the quantity of the repetitions transmitted is based on a count of uplink and downlink slots of the set of the plurality of slots from a first repetition of the uplink transmission until the count reaches the repetition count.

Example 16. The method, apparatus, and non-transitory computer-readable medium of any of Examples 1 to 15, wherein the repetitions are transmitted on one or more corresponding physical uplink shared channels (PUSCHs) corresponding to the subset of the plurality of slots.

Example 17. The method, apparatus, and non-transitory computer-readable medium of any of Examples 1 to 16, wherein the first carrier is a frequency division duplex (FDD) carrier.

Example 18. The method, apparatus, and non-transitory computer-readable medium of any of Examples 1 to 17, wherein each repetition is transmitted over a same resource location in each slot of the subset of the plurality of slots.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as 5G, Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-13 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-13 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A method of wireless communication operable at a scheduling entity, comprising:
transmitting an indication of a first repetition count to a first user equipment (UE);
transmitting, to the first UE, a first resource allocation for a set of a plurality of first slots on a first carrier, the first carrier paired with a second carrier and separated from the second carrier in frequency, wherein the first UE operates in a half-duplex communication; and
receiving, from the first UE, repetitions of a first uplink transmission on a first subset of the plurality of first slots on the first carrier, wherein a first quantity of the repetitions that are received is based on the first repetition count.

2. The method of claim 1, further comprising:
transmitting an indication of a second repetition count to a second UE;
transmitting, to the second UE, a second resource allocation for a set of a plurality of second slots on a third carrier, the third carrier paired with a fourth carrier and separated from the fourth carrier in frequency, wherein the first UE operates in a full-duplex communication; and
receiving, from the second UE, repetitions of a second uplink transmission on a second subset of the plurality of second slots on the third carrier, wherein a second quantity of the repetitions of the second uplink transmission that are received is based on the first repetition count.

3. The method of claim 2, wherein the repetitions of the first uplink transmission are associated with a first repetition counting procedure and the repetitions of the second uplink transmission are associated with a second repetition counting procedure.

4. The method of claim 3, wherein, for the first repetition counting procedure, the first quantity of the repetitions transmitted is based on a count of available uplink slots of the set of the plurality of first slots from a first repetition of the first uplink transmission until the count reaches the first repetition count.

5. The method of claim 4, wherein for the second repetition counting procedure, the second quantity of the repetitions transmitted is based on a count of uplink and downlink slots of the set of the plurality of second slots from a first repetition of the second uplink transmission until the count reaches the second repetition count.

6. The method of claim 3, further comprising:
transmitting, to the first UE, a first indication of the first repetition counting procedure; and
transmitting, to the second UE, a second indication of the second repetition counting procedure.

7. The method of claim 3, wherein the first repetition counting procedure is fixedly associated with the first UE and wherein the second repetition counting procedure is fixedly associated with the second UE.

8. The method of claim 3, further comprising:
transmitting, to the first UE, a first indication of the first repetition counting procedure, and
wherein the second repetition counting procedure is fixedly associated with the second UE.

9. The method of claim 3, further comprising:
transmitting, to the second UE, a second indication of the second repetition counting procedure, and
wherein the first repetition counting procedure is fixedly associated with the first UE.

10. The method of claim 1, further comprising:
transmitting, to the first UE, a first indication of a first repetition counting procedure, wherein the repetitions of the first uplink transmission are associated with the first repetition counting procedure.

11. The method of claim 10, wherein, for the first repetition counting procedure:
(i) the first quantity of the repetitions transmitted is based on a count of uplink and downlink slots of the set of the plurality of first slots from a first repetition of the first uplink transmission until the count reaches the first repetition count, or
(ii) the first quantity of the repetitions transmitted is based on a count of available uplink slots of the set of the plurality of first slots from a first repetition of the first uplink transmission until the count reaches the first repetition count.

12. A method of wireless communication operable at a user equipment (UE), comprising:
receiving an indication of a repetition count from a scheduling entity;
receiving a resource allocation for a set of a plurality of slots on a first carrier, the first carrier paired with a second carrier and separated from the second carrier in frequency, wherein the UE operates in a half duplex communication; and
transmitting repetitions of an uplink transmission on a subset of the plurality of slots on the first carrier, wherein a quantity of the repetitions transmitted is based on the repetition count.

13. The method of claim 12, further comprising:
receiving an indication of a repetition counting procedure for counting of the quantity of the repetitions.

14. The method of claim 12, wherein the quantity of the repetitions transmitted is based on a count of available uplink slots of the set of the plurality of slots from a first repetition of the uplink transmission until the count reaches the repetition count, or the quantity of the repetitions transmitted is based on a count of uplink and downlink slots of the set of the plurality of slots from a first repetition of the uplink transmission until the count reaches the repetition count.

15. The method of claim 12, wherein the repetitions are transmitted on one or more corresponding physical uplink shared channels (PUSCHs) corresponding to the subset of the plurality of slots.

16. A scheduling entity for wireless communication, comprising:
a processor; and
a memory communicatively coupled to the processor,
wherein the memory stores instructions executable by the processor to cause the scheduling entity to:
transmit an indication of a first repetition count to a first user equipment (UE);
transmit, to the first UE, a first resource allocation for a set of a plurality of first slots on a first carrier, the first carrier paired with a second carrier and separated from the second carrier in frequency, wherein the first UE is configured to operate in a half-duplex communication; and
receive, from the first UE, repetitions of a first uplink transmission on a first subset of the plurality of first slots on the first carrier, wherein a first quantity of the repetitions that are received is based on the first repetition count.

17. The scheduling entity of claim 16, wherein the memory further stores instructions executable by the processor to cause the scheduling entity to:
transmit an indication of a second repetition count to a second UE;
transmit, to the second UE, a second resource allocation for a set of a plurality of second slots on a third carrier, the third carrier paired with a fourth carrier and separated from the fourth carrier in frequency, wherein the first UE is configured to operate in a full-duplex communication; and
receive, from the second UE, repetitions of a second uplink transmission on a second subset of the plurality of second slots on the third carrier, wherein a second quantity of the repetitions of the second uplink transmission that are received is based on the first repetition count.

18. The scheduling entity of claim 17, wherein the repetitions of the first uplink transmission are associated with a first repetition counting procedure and the repetitions of the second uplink transmission are associated with a second repetition counting procedure.

19. The scheduling entity of claim 18, wherein, for the first repetition counting procedure, the first quantity of the repetitions transmitted is based on a count of available uplink slots of the set of the plurality of first slots from a first repetition of the first uplink transmission until the count reaches the first repetition count.

20. The scheduling entity of claim 19, wherein for the second repetition counting procedure, the second quantity of the repetitions transmitted is based on a count of uplink and downlink slots of the set of the plurality of second slots from a first repetition of the second uplink transmission until the count reaches the second repetition count.

21. The scheduling entity of claim 19, wherein the memory further stores instructions executable by the processor to cause the scheduling entity to:
transmit, to the first UE, a first indication of the first repetition counting procedure; and
transmit, to the second UE, a second indication of the second repetition counting procedure.

22. The scheduling entity of claim 19, wherein the first repetition counting procedure is fixedly associated with the first UE and wherein the second repetition counting procedure is fixedly associated with the second UE.

23. The scheduling entity of claim 19, wherein the memory further stores instructions executable by the processor to cause the scheduling entity to:
transmit, to the first UE, a first indication of the first repetition counting procedure, and
wherein the second repetition counting procedure is fixedly associated with the second UE.

24. The scheduling entity of claim 17, wherein the memory further stores instructions executable by the processor to cause the scheduling entity to:
transmit, to the first UE, a first indication of a first repetition counting procedure, wherein the repetitions of the first uplink transmission are associated with the first repetition counting procedure.

25. The scheduling entity of claim 24, wherein, for the first repetition counting procedure:
(i) the first quantity of the repetitions transmitted is based on a count of uplink and downlink slots of the set of the plurality of first slots from a first repetition of the first uplink transmission until the count reaches the first repetition count, or
(ii) the first quantity of the repetitions transmitted is based on a count of available uplink slots of the set of the plurality of first slots from a first repetition of the first uplink transmission until the count reaches the first repetition count.

26. A user equipment (UE) for wireless communication, comprising:
a processor;
a memory communicatively coupled to the processor,
wherein the memory stores instructions executable by the processor to cause the UE to:
receive an indication of a repetition count from a scheduling entity;
receive a resource allocation for a set of a plurality of slots on a first carrier, the first carrier paired with a second carrier and separated from the second carrier in frequency, wherein the UE is configured to operate in a half duplex communication; and
transmit repetitions of an uplink transmission on a subset of the plurality of slots on the first carrier, wherein a quantity of the repetitions transmitted is based on the repetition count.

27. The UE of claim 26, wherein the memory further stores instructions executable by the processor to cause the UE to:
receive an indication of a repetition counting procedure for counting of the quantity of the repetitions.

28. The UE of claim 26, wherein the quantity of the repetitions transmitted is based on a count of available uplink slots of the set of the plurality of slots from a first repetition of the uplink transmission until the count reaches the repetition count.

29. The UE of claim 26, wherein the quantity of the repetitions transmitted is based on a count of uplink and downlink slots of the set of the plurality of slots from a first repetition of the uplink transmission until the count reaches the repetition count.

30. The UE of claim 26, wherein the repetitions are transmitted on one or more corresponding physical uplink shared channels (PUSCHs) corresponding to the subset of the plurality of slots.
